(19) United States
(12) Patent Application Publication
(10) Pub. No.: US 2017/0149743 A1
(43) Pub. Date: May 25, 2017

(54) COMMUNICATION APPARATUS AND METHOD FOR DETECTING ABNORMALITY OF ENCRYPTION COMMUNICATION

(71) Applicant: FUJITSU LIMITED, Kawasaki-shi (JP)

(72) Inventor: Isamu Fukuda, Yokohama (JP)

(73) Assignee: FUJITSU LIMITED, Kawasaki-shi (JP)

(21) Appl. No.: 15/332,093

(22) Filed: Oct. 24, 2016

(30) Foreign Application Priority Data
Nov. 19, 2015 (JP) 2015-226782

(51) Int. Cl. H04L 29/06

(52) U.S. Cl. CPC H04L 63/0428

(57) ABSTRACT

A communication apparatus includes: a memory configured to store negotiation information used to negotiate a path of encryption communication established with a opposite apparatus; and a processor coupled to the memory and configured to execute a monitoring process. The monitoring process includes a process of monitoring a monitoring target packet specified using the negotiation information among a plurality of packets transmitted and received on the path, and a process of detecting abnormality of the encryption communication in a case in which the monitoring target packet is not received within a predetermined time.

### CROSS-REFERENCE TO RELATED APPLICATION

This application is based upon and claims the benefit of priority of the prior Japanese Patent Application No. 2015-226782, filed on Nov. 19, 2015, the entire contents of which are incorporated herein by reference.

### FIELD

The embodiments discussed herein are related to a communication apparatus and a method for detecting abnormality of encryption communication.

### BACKGROUND

As one of the security protocols of the network layer, there is a security architecture for the Internet Protocol (IPsec). The IPsec provides alternation prevention or a concealment function for data in units of IP packets using an encryption communication technology. In the IPsec, an encryption path (tunnel) called “IPsec_SA (Security Association)” is established between apparatuses which terminate the IPsec. Packets transmitted using the IPsec_SA (also referred to as an “IPsec tunnel”) are encrypted and encapsulated by encapsulation security payload (ESP).

As a protocol for automatically establishing an IPsec_SA, a key exchange protocol called an Internet key exchange (IKE) is used. In the IKE, negotiation is executed to establish a tunnel for the IKE called an “IKE_SA” between apparatuses which terminate the IPsec and to establish an IPsec_SA such as exchange of a cipher key of the IPsec or exchange of a parameter related to the IPsec_SA using the IKE_SA.

In the related art, an IPsec layer, that is, an IPsec_SA, is monitored using an alive monitoring mechanism called dead peer detection (DPD). The DPD detects disconnection of an IPsec tunnel by disconnection (dead) of the IKE_SA. In other words, communication (connectivity) between apparatuses which terminate the IPsec is determined by the DPD.

A protocol of an upper layer of the IPsec has a regular monitoring function of the IPsec tunnel in some cases. For example, the Internet control message protocol (ICMP) which is a protocol of an upper layer of the IPsec executes periodic ping transmission (ICMP echo) to detect a failure of the IPsec in a case in which there is no reply. In this way, the upper layer monitors the IPsec_SA in some cases.

As examples of the related art, Japanese Laid-open Patent Publication No. 2008-205806, Japanese Laid-open Patent Publication No. 2012-231368, Japanese Laid-open Patent Publication No. 2005-20215, and Japanese Laid-open Patent Publication No. 2005-253061 are known.

### SUMMARY

According to an aspect of the invention, a communication apparatus includes: a memory configured to store negotiation information used to negotiate a path of encryption communication established with a opposite apparatus; and a processor coupled to the memory and configured to execute a monitoring process. The monitoring process includes a process of monitoring a monitoring target packet specified using the negotiation information among a plurality of packets transmitted and received on the path, and a process of detecting abnormality of the encryption communication in a case in which the monitoring target packet is not received within a predetermined time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a mobile communication system;

FIG. 2 is a diagram illustrating an example of the configuration of a wireless base station apparatus;

FIG. 3 is a diagram illustrating an example of the configuration of an information processing apparatus (computer) which can operate as a security gateway;

FIG. 4 is a diagram schematically illustrating an example of the configuration of a control unit illustrated in FIGS. 2 and 3;

FIG. 5 is a diagram illustrating an example of a data structure of an SPD stored in a memory;

FIG. 6 is a diagram illustrating an example of the data structure of the SPD stored in a memory;

FIG. 7 is a diagram illustrating an example of the data structure of the SPD stored in a memory;

FIG. 8 is a diagram illustrating an example of a data structure of monitoring information;

FIG. 9 is a diagram illustrating an example of a data structure of monitoring information;

FIG. 10 is a diagram illustrating an example of a data structure of monitoring information;

FIG. 11 is a diagram illustrating an example of a data structure of monitoring information;

FIG. 12 is an explanatory diagram illustrating a protocol stack according to an embodiment;

FIG. 13 is a sequence diagram illustrating an operation example according to the embodiment;

FIG. 14 is a sequence diagram illustrating an operation example according to the embodiment;

FIG. 15 is a sequence diagram illustrating an operation example according to the embodiment;

FIG. 16 is a sequence diagram illustrating an operation example according to the embodiment;

FIG. 17 is a sequence diagram illustrating an operation example according to the embodiment;

FIG. 18 is a flowchart illustrating an example of a negotiation process (a monitoring side);

FIG. 19 is a flowchart illustrating an example of a negotiation process (a monitored side);

FIG. 20 is a flowchart illustrating an example of a monitoring process;

FIG. 21 is a flowchart illustrating an example of the monitoring process;

FIG. 22 is a flowchart illustrating an example of a packet encryption/decryption process;

FIG. 23 is a flowchart illustrating an example of a recovery method/recovery state reception process;

FIG. 24 is a diagram illustrating a format example of an IKE packet;

FIG. 25 is a diagram illustrating a format example of an IKE packet used as a negotiation packet;

FIG. 26 is a diagram illustrating a format example of a monitoring start/monitoring target packet; and

FIG. 27 is a diagram illustrating a format example of a monitoring start/monitoring target packet of non-encryption.

### DESCRIPTION OF EMBODIMENTS

A DPD in a technology of the related art is a method for monitoring an IPsec tunnel that indirectly detects abnormality of the IPsec tunnel according to whether an IKE_SA is normal. In the technology of the related art, however, even when the IKE_SA is normal, it is difficult to establish the normal IPsec tunnel, for example, in a case in which parameters of the IPsec_SA do not match between termination apparatuses. Therefore, there is a possibility of encryption communication not being executed by the IPsec. In this way, in the DPD, it is difficult to detect abnormality of IPsec_SA and communication abnormality of an upper layer using the IPsec tunnel.

In contrast, abnormality of the IPsec tunnel can be detected when the IPsec is monitored by an upper layer. However, in the method for monitoring an IPsec by an upper layer in the related art, a monitoring function is mounted not only on apparatuses which terminate the IPsec but also on apparatuses which terminate the upper layer. In this way, in the monitoring of the IPsec by the upper layer, complexity or complication of a monitoring mechanism is caused and it is difficult to mount the monitoring function in many cases.

As one aspect of the present embodiment, provided are solutions for being able to perform detecting abnormality of encryption communication undetectable in monitoring of a lower layer with a simple configuration.

Hereinafter, embodiments will be described with reference to the drawings. Configurations of the embodiments are exemplary and the disclosure is not limited to the configuration of the embodiments.

In an embodiment, a communication apparatus that executes encryption communication with a opposite apparatus (peer) will be described. In the embodiment, an IPsec is an example of a protocol for “encryption communication” in the description. An IPsec_SA (IPsec tunnel) is an example of an “encryption communication path”.

The IPsec_SA is established between the communication apparatus and the opposite apparatus. The communication apparatus includes a storage unit that stores negotiation information used for negotiation of a path for an encryption communication (encryption communication path) established with the opposite apparatus. The negotiation information is, for example, information registered in a security policy database (SPD) of the IPsec.

In the embodiment, the communication apparatus includes a monitoring unit that monitors a monitoring target packet specified using the negotiation information among a plurality of packets transmitted and received on a path (IPsec_SA) for encryption communication. The monitoring unit is configured to detect abnormality of the encryption communication in a case in which the monitoring target packet is not received within a predetermined time.

The SPD according to the embodiment includes not only information for negotiating specification of the IPsec_SA with the opposite apparatus but also information indicating a monitoring condition of the IPsec_SA and information indicating a recovery method for a failure of the IPsec_SA. The information indicating the monitoring condition is an example of “negotiation information of the monitoring target packet” and the information indicating the recovery method is an example of “negotiation information of the recovery method”.

In the embodiment, apparatuses which terminate the IPsec execute negotiation of the monitoring target packet monitored to detect abnormality of the IPsec_SA in the negotiation establishing the IPsec_SA. A negotiation message can include not only first information used in the negotiation for establishing the IPsec_SA (encryption communication path) and second information used for negotiation related to monitoring of the encryption communication path. The negotiation message can also include information (third information) used for negotiation of the recovery method. Such a message is transmitted to the opposite apparatus. The opposite apparatus transmits a reply message that includes information indicating a monitoring target packet or a recovery method selected by the opposite apparatus.

As a result of the negotiation (message exchange), the IPsec_SA (IPsec tunnel) is established. Further, the monitoring target packet is monitored to detect abnormality of the IPsec tunnel. By monitoring the monitoring target packet, a packet communication situation (packet transmission and reception situation) of an upper layer (for example, an ICMP or a GTP) of the IPsec is monitored. In a case in which abnormality is detected from the monitoring result, a process based on the recovery method decided by the negotiation is executed. By executing the recovery method, it is possible to resolve communication abnormality of an upper layer of the IPsec caused due to a failure of the IPsec layer.

In the embodiment, a plurality of candidates of the monitoring condition of the IPsec_SA and a plurality of candidates of the recovery method are registered in the SPD. In the negotiation executed between apparatuses (devices) which determinate the IPsec_SA at the time of establishment of the IPsec_SA, the monitoring condition or the monitoring condition and the recovery method are negotiated.

In the negotiation, a plurality of recovery methods are decided in some cases. In this case, the plurality of recovery methods are used step by step based on recovery states. That is, when recovery is not made by a certain recovery method, another recovery method is executed. The recovery method may be changed by executing steps of managing a recovery state, updating the recovery state according to a use result of the recovery method, and implementing a subsequent recovery method. It is preferable to manage the recovery state such that the recovery state does not return to an initial value even when the recovery state is stored in a nonvolatile storage medium and a device or the IPsec is reset.

As described above, the monitoring condition and the recovery method of the IPsec are registered in advance in the SPD. For example, in the monitoring of packets transmitted and received using the IPsec, reception of reply packets of the packets within a predetermined period is monitored using reception of a certain kind of packet as an opportunity. The certain kind of packet is referred to as a “monitoring start packet” and the reply packet of the certain kind of packet is referred to as a “monitoring target packet”.

For example, an ICMP packet, an SCTP packet, and a GTP packet transmitted and received using the IPsec can be exemplified as the packets of the upper layer. A packet referred to as an echo request and including a message which requests a reply can be set as the monitoring start packet. The reply packet of a packet of the echo request is monitored as the monitoring target packet. The reply packet is referred to as an echo reply packet or a reply packet.

Clocking of a predetermined time starts using reception of the monitoring start packet (the echo packet) as an opportunity. The predetermined time is clocked with, for example, a monitoring timer. When the monitoring target packet (reply packet) is received before expiration (timeout) of the monitoring timer, communication of the upper layer is normal. Conversely, in a case in which the monitoring timer expires without receiving the monitoring target packet, the communication of the upper layer is determined to be abnormal (abnormality is detected). In this case, the recovery method mutually agreed in advance in the negotiation is executed to implement communication recovery.

For example, the following condition can be adopted as the monitoring condition. For example, each of the “monitoring start packet” and the “monitoring target packet” can be regulated using at least one of a target IP address, a protocol, a port number, and identification information of the upper layer.

For a parameter (which is an example of “specific information”) for specifying a packet, common information to a parameter (specific information) used to specify a packet (traffic) in the negotiation for establishing the IPsec_SA is used. Accordingly, information registered in the SPD can be effectively utilized to establish the IPsec_SA, and thus simplicity of information management is achieved.

The monitoring start condition (for example, reception of the monitoring start packet), an end condition (for example, reception of the monitoring target packet, reception of a monitoring stop packet, or expiration of the monitoring timer), and a monitoring period are decided as the monitoring conditions.

A single recovery method or a plurality of recovery methods are regulated as the recovery method. In a case in which the plurality of recovery methods are regulated, priority of the recovery methods is decided. As the recovery methods, reset of the IPsec, re-establishment of the IPsec_SA, reset of an IPsec function, and reset of at least one of the communication apparatus and the opposite apparatus can be exemplified. One of a monitoring side and a monitored side can serve as an entity implementing the recovery method. The monitoring side refers to a reception side of the monitoring target packet and the monitored side refers to a transmission side of the monitoring target packet.

A rough order executed in the embodiment is as follows.

(1) With negotiation by a message using the IKE packet at the time of establishment of the IPsec_SA, the monitoring condition of the IPsec_SA and information regarding the recovery method are shared between the apparatuses which terminate the IPsec_SA. At this time, by sharing (agreeing) the recovery method supported by both of an initiator and a responder of the IPsec, compatibility between both of the initiator and the responder, that is, execution of the recovery method, is ensured.

(2) In a case in which reception of the monitoring start packet in the monitoring condition of the IPsec_SA registered in the SPD is detected, the monitoring timer is activated and it is monitored whether the monitoring target packet is received before expiration of the monitoring timer. At this time, it may be periodically monitored whether the monitoring target packet is received.

In a case in which the monitoring target packet does not arrive (is not received) irrespective of the establishment of the IKE_SA (where the monitoring timer stops during disconnection of the IPsec tunnel), abnormality of the IPsec layer (communication abnormality of the upper layer) is determined. At this time, one recovery method decided by the negotiation is implemented. In a case in which two or more recovery methods are decided, one of the two or more recovery methods is implemented according to the priority.

In a case in which abnormality is not recovered despite the execution of two or more recovery methods decided to be executed, a maintenance person can be notified of occurrence of the abnormality (failure). In this way, potentiality of the abnormality of the IPsec is avoided. Hereinafter, a configuration of the embodiment will be described in detail.

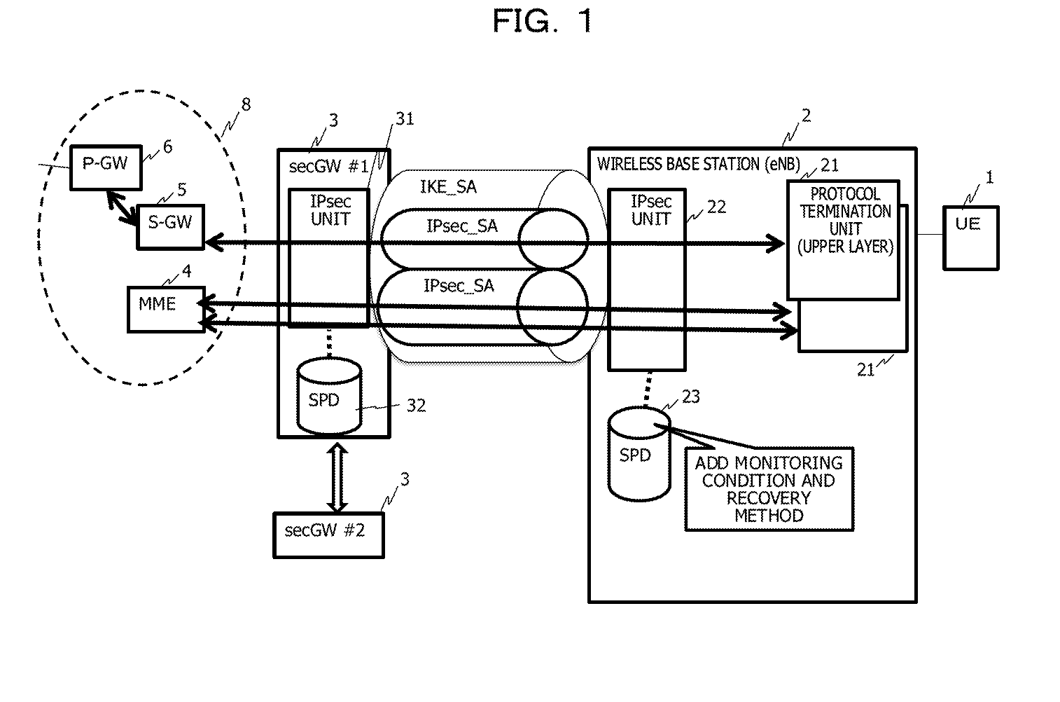

FIG. 1 is a diagram illustrating an example of a mobile communication system. The mobile communication system is suitable for or conforms with, for example, Long Term Evolution (LTE). However, the mobile communication system may conform to a wireless communication standard other than LTE. Examples of the wireless communication standard other than LTE include Wideband Code Division Multiple Access (W-CDMA) or Global System for Mobile communication (GSM (registered trademark)). However, the disclosure is not limited thereto. The wireless communication standard may be a wireless local area network (LAN: IEEE 802.11 series or Wi-Fi).

In the example illustrated in FIG. 1, the mobile communication system includes a wireless terminal (user equipment (UE): hereinafter referred to as a “terminal”) 1, a wireless base station (eNB: hereinafter referred to as a “base station”) 2 that executes wireless communication, and a security gateway (secGW) 3. The mobile communication system further includes a serving gateway (S-GW) 5 and a mobility management entity (MME) 4 connected to the secGW 3. The base station 2 and the secGW 3 are examples of the “communication apparatus” and the “opposite apparatus”, respectively.

An LTE network includes a core network 8 and a wireless network. The wireless network is formed by the base station 2. The S-GW 5 and the MME 4 are nodes which form the core network 8. The core network 8 further includes a packet data network gateway (P-GW) 6 as a node which forms the core network 8. The P-GW 6 is connected to the S-GW 5.

The secGW 3 is disposed between the wireless network (the base station 2) and the core network 8. One or more secGWs 3 can be provided. In the example of FIG. 1, two secGWs 3 (secGW #1 and secGW #2) are exemplified.

The terminal 1 which desires to execute communication using the LTE network is wirelessly connected to the base station 2 and transmits a connection request to the LTE network to the MME 4 via the base station 2. The MME 4 executes a position registration process of the terminal 1 and controls setting of a communication path (a path: also referred to as a “bearer”) through which the terminal 1 transmits and receives user packets via the LTE network.

The bearer is set between the S-GW 5 and the base station 2. Further, a wireless bearer is set between the base station 2 and the terminal 1. The bearer between the base station 2 and the S-GW 5 is connected to the bearer set between the S-GW 5 and the P-GW 6. The P-GW 6 is a gateway to an external network (not illustrated and the Internet, for example) to which a communication partner of the terminal 1. The P-GW 6 sends out packets from the terminal 1 to an external network, or receives packets destined for the terminal 1 from an external network and transmits the packets to the S-GW 5.

From another viewpoint, a communication path (path) of a control plane (C plane) is set between the base station 2 and the MME 4. On the other hand, a communication path (path (bearer)) of a user plane (U plane) is set between the base station 2 and the S-GW 5 (the P-GW 6). The secGWs 3 are interposed between the base station 2 and the S-GW 5 and between the base station 2 and the MME 4. The secGW 3 establishes key exchange connection based on the IKE with the base station 2. Such connection is referred to as security association (SA).

Hereinafter, SA established based on the IKE is referred to as “IKE_SA”. The secGW 3 establishes IPsec connection (referred to as “IPsec_SA or “IPsec tunnel”) corresponding to each of the path of the C plane and the path of the U plane with the base station 2. Packets passing through the IPsec tunnel are encrypted by the ESP. The IPsec_SA (the IPsec tunnel) is an example of an “encryption communication path”.

The base station 2 includes a protocol termination unit 21 that terminates a protocol (a protocol of an upper layer of the IPsec) related to each communication of the C plane and the U plane and an IPsec unit 22 that encrypts or decrypts packets (datagrams) based on the IPsec. The base station 2 further includes a security policy database (SPD) 23. On the other hand, the secGW 3 also includes an IPsec unit 31 corresponding to the IPsec unit 22 and an SPD 32.

The SPD is a set of security policies (SPs). Each SP is defined from data in a packet to be referred to (parameter: also referred to as a “selector”) and content of a process executed according to content of the selector (for example, “encryption”, “decryption”, “none”, and “discard”).

For example, the IPsec unit 22 of the base station 2 decides a process to be executed on a packet with reference to the SPD 23 and the selector in a packet destined for the MME 4 or the S-GW 5. For example, when the process is “encryption”, a payload of the packet is encrypted based on encapsulated security payload (ESP), the packet is encapsulated with an ESP header and a remote IP header, and the packet is transmitted to the IPsec_SA.

The IPsec unit 31 of the secGW 3 executes a process on a packet, for example, decryption on the packet, using the SPD 32 and the selector in the encapsulated packet from the base station 2 and transmits the decapsulated packet to a destination (the MME 4 or the S-GW 5). The foregoing description is description for an uplink direction, but the same processes are also executed for a downlink direction. In the example of FIG. 1, the common IPsec tunnel is present between the uplink and the downlink in the drawing. Actually, different IPsec tunnels are established in the uplink and the downlink.

Each of the SPD 23 and the SPD 32 is stored in a storage device (for example, a memory 204). The storage device is an example of a “storage unit that stores negotiation information”. The mobile communication system illustrated in FIG. 1 has been exemplified as an example in which the monitoring method related to the IPsec is applied. In the present description, the monitoring method and the recovery method according to the embodiment may be broadly applied to various communication apparatuses which execute a communication operation using the IPsec between two points. That is, the monitoring method and the recovery method according to the embodiment can broadly be applied to networks other than the mobile communication systems.

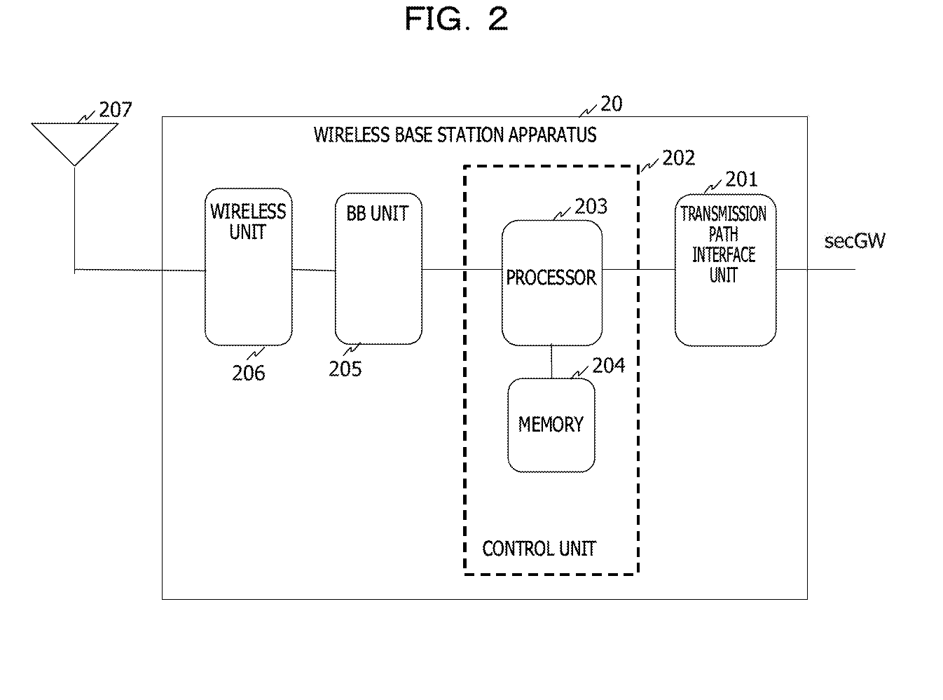

FIG. 2 is a diagram illustrating an example of the configuration of the wireless base station 20 which can be applied as the base station 2. The wireless base station 20 (hereinafter referred to as a “base station 20”) includes a transmission path interface unit 201, a control unit 202, a baseband (BB) unit, a wireless (RF: Radio Frequency) unit 206, and an antenna 207. The control unit 202 includes a processor 203 and a memory 204.

The transmission path interface unit 201 accommodates a line of a transmission path such as an LAN or a WAN and is connected to the secGW 3 via the transmission path. The transmission path interface unit 201 governs a process of transmitting and receiving packets along the transmission path. A communication device or a circuit chip set called a LAN card or a network interface card (NIC) can be applied as the transmission path interface unit 201.

The baseband unit 205 (the BB unit 205) executes a conversion process between data and a baseband signal. The data converted from the baseband signal is supplied to the control unit 202. The baseband signal obtained by converting the data is transmitted to the wireless unit 206.

The wireless unit 206 executes a conversion process between a wireless signal and a baseband signal or a process of amplifying a wireless signal. The wireless unit 206 converts a baseband signal from the BB unit 205 into a wireless signal and amplifies the wireless signal. The amplified wireless signal is radiated from the antenna 207 and is received by the terminal 1. The wireless unit 206 executes low-noise amplification on the wireless signal from the terminal 1 and received by the antenna 207, converts the wireless signal into the baseband signal, and transmits the baseband signal to the BB unit 205.

As described above, the control unit 202 includes a processor 203 and a memory 204 connected to the processor 203. The memory 204 can include a main storage device and an auxiliary storage device.

The main storage device is used as, for example, a program development area, a data storage area (buffer area), and a working area of the processor. The main storage device is, for example, a random access memory (RAM) or a combination of a RAM and a read-only memory (ROM). The ROM stores data used at the time of execution of a program (firmware) and a program.

The auxiliary storage device is used as a storage area of a program and data. The auxiliary storage device is, for example, a nonvolatile storage medium such as a hard disk drive (HDD), a solid-state drive (SSD), a flash memory, or an electrically erasable programmable read-only memory (EEPROM).

The processor 203 is, for example, at least one central processing unit (CPU). However, the processor 203 may be formed by a plurality of CPUs or a CPU that has a plurality of cores. The processor 203 may be formed by a combination of a plurality of types of processors. The combination is, for example, a combination of a CPU and a digital signal processor (DSP).

The processor 203 loads a program stored in the auxiliary storage device or the ROM to the main storage device (the RAM) and executes the program. Accordingly, the processor 203 can exert various functions of the base station 20. For example, the processor 203 exerts as the protocol termination unit 21 and the IPsec unit 22 of the above-described upper layer by executing the program. In other words, by executing a computer program stored in the memory on the processor 203, the processor 203 can operate as a hardware circuit capable of executing some or all of the processes of the protocol termination unit 21 and the IPsec unit 22 of the above-described upper layer. The function exerted by the processor 203 may be exerted by a system LSI or hardware.

The system LSI is a device in which a processor and a peripheral circuit are mounted on one chip. The hardware is formed by, for example, an electric circuit, an electronic circuit, a semiconductor device, or a combination thereof. The semiconductor device includes a programmable logic device (PLD) such as a field programmable gate array (FPGA) or an integrated circuit (an IC, an LSI, an application specific integrated circuit (ASIC), or the like).

Each of the control unit 202 and the processor 203 is an example of a “monitoring unit”, a “recovery unit”, and a “negotiation unit”. The memory 204 is an example of a “storage unit”. For example, the auxiliary storage device included in the memory 204 is used as a nonvolatile storage medium that stores a “recovery state” to be described below.

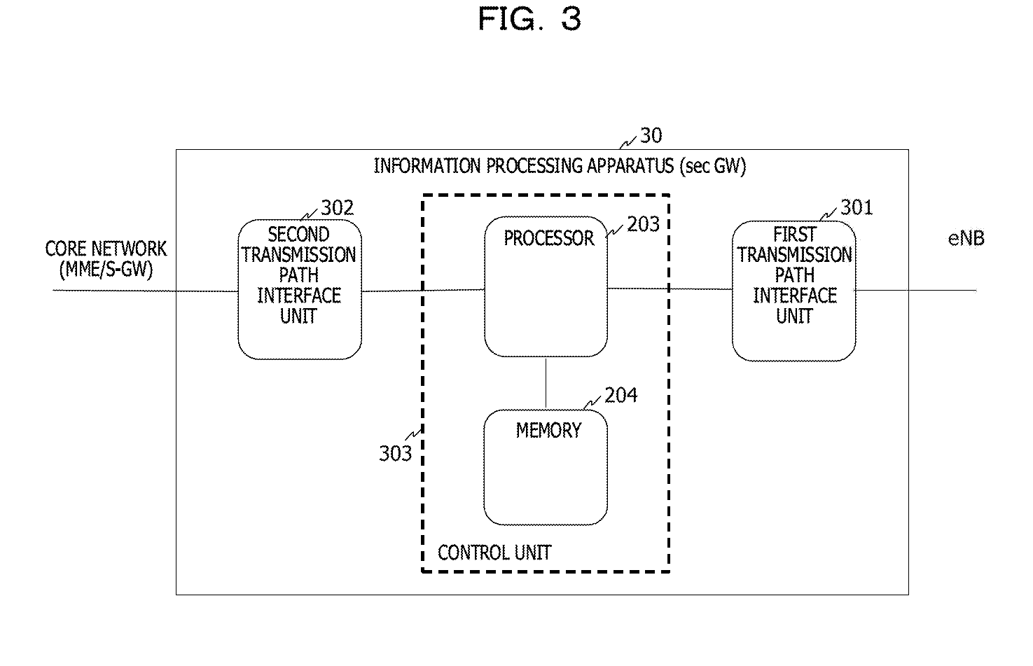

FIG. 3 is a diagram illustrating an example of the configuration of an information processing apparatus (computer) 30 which can operate as the secGW. In FIG. 3, the information processing apparatus 30 includes a first transmission path interface unit 301, a second transmission path interface unit 302, and a control unit 303. The first transmission path interface unit 301 accommodates a transmission path connected to the base station 2. The second transmission path interface unit 302 accommodates a transmission path connected to each of the MME 4 and the S-GW 5 of the core network 8. The above-described LAN cards or NICs can be applied as the first transmission path interface unit 301 and the second transmission path interface unit 302.

The control unit 303 includes a processor 203 and a memory 204 connected to the processor 203 as in the control unit 202. The same processor and memory as the processor 203 and the memory 204 included in the above-described base station 20 can be applied as the processor 203 and the memory 204 included in the information processing apparatus 30.

The control unit 303 and the processor 203 are each examples of a “monitoring unit”, a “recovery unit” and a “negotiation unit”. The memory 204 is an example of a “storage unit”. For example, an auxiliary storage device forming the memory 204 can be used as a nonvolatile storage medium that stores a “recovery state”.

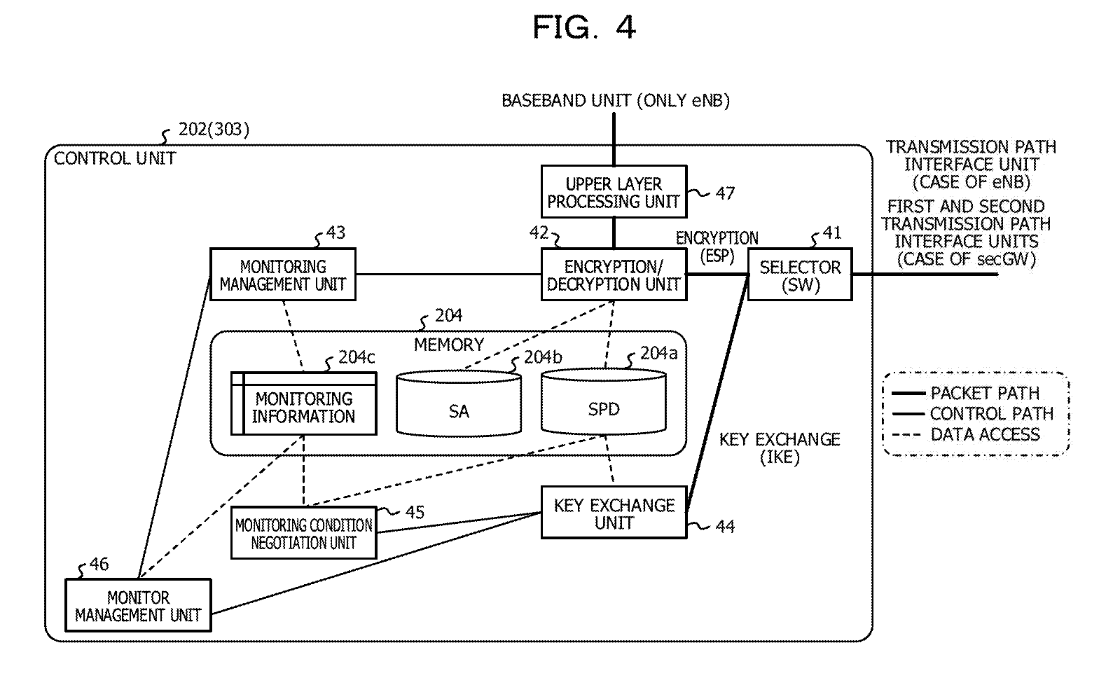

FIG. 4 is a diagram schematically illustrating an example of the configuration of the control unit 202 illustrated in FIG. 2 and the control unit 303 illustrated in FIG. 3. The processor 203 operates as the control unit 202 or 303 by executing a program. That is, the processor 203 can operate as a selector (SW) 41, an encryption/decryption unit 42, a monitoring management unit 43, a key exchange unit 44, a monitoring condition negotiation unit 45, and a recovery management unit 46.

Here, the processor 203 of the base station 20 also operates as a processing unit 47 of the upper layer. The memory 204 stores SPD information 204a, SA information 204b, and monitoring information 204c. Different hardware from the processor 203 may be prepared as the selector (SW) 41.

In the control unit 202 included in the base station 20, the upper layer processing unit 47 (the processor 203) is connected to the BB unit 205. The selector 41 (the processor 203) included in the base station 20 is connected to the transmission path interface unit 201 (see FIG. 2). On the other hand, the control unit 303 included in the information processing apparatus 30, the selector 41 (the processor 203) is connected to the first transmission path interface unit 301 and the second transmission path interface unit 302 (see FIG. 3).

The monitoring management unit 43 is an example of a “monitoring unit”. The monitoring condition negotiation unit 45 is an example of a “negotiation unit”. The recovery management unit 46 is an example of a “recovery unit”.

The selector 41 determines kinds of protocols of packets (signals) input from the transmission path interface unit 201, the first transmission path interface unit 301 and the second transmission path interface unit 302 and distributes the packets to corresponding processes. For example, the selector 41 determines whether the kind of protocol is the ESP or the IKE. In a case in which the kind of protocol is the ESP, the packet is delivered to the encryption/decryption unit 42. Conversely, in a case in which the kind of protocol is the IKE, the packet is delivered to the key exchange unit 44. The selector 41 outputs the packet to any of the transmission path interface unit 201, the first transmission path interface unit 301, and the second transmission path interface unit 302 according to a destination of the packet.

The encryption/decryption unit 42 encrypts and decrypts the packet. Specifically, the encryption/decryption unit 42 executes packet analysis and retrieves the SPD and the IPsec_SA corresponding to the packet. Upon the retrieval, the SPD information 204a and the SA information 204b of the memory 204 are referred to. The encryption/decryption unit 42 decrypts an ESP packet and encrypts a plaintext packet based on the ESP. The encryption/decryption unit 42 operates the monitoring management unit 43 when a monitoring start target packet or a monitoring target packet is received.

The key exchange unit 44 exchanges an encryption key. Specifically, the key exchange unit 44 executes a termination process of a key exchange protocol (IKE) executes key exchange (establishment of the IKE_SA and negotiation of the IPsec_SA) with the secGW 3. An IKE packet for the establishment of the IPsec_SA includes information for negotiation of a monitoring condition (which is an example of “information for negotiation of a monitoring target packet”) and information for negotiation of a recovery method.

The monitoring condition negotiation unit 45 and the recovery management unit 46 can start an operation using reception of the IKE packet (negotiation packet) for the establishment of the IPsec_SA as an opportunity. The monitoring condition negotiation unit 45 manages the monitoring condition. The monitoring condition negotiation unit 45 sets negotiation parameter (proposal) granted to the IKE packet based on candidates of the recovery method and the monitoring condition added to the SPD. The monitoring condition negotiation unit 45 reflects the monitoring condition and the recovery method replied from the opposite apparatus to the monitoring information 203c based on a negotiation result.

The monitoring management unit 43 manages the monitoring of the IPsec_SA. That is, the monitoring management unit 43 activates a monitoring timer at the time of reception of the monitoring start packet. The monitoring management unit 43 reactivates the monitoring timer at the time of reception of the monitoring target packet. The monitoring management unit 43 operates the recovery management unit 46 at the time of timeout of the monitoring timer. Further, the monitoring management unit 43 updates a monitoring state.

The recovery management unit 46 executes a recovery process for the IPsec_SA in which abnormality is detected. The recovery management unit 46 executes a recovery process according to a recovery state (degree of escalation). In a case in which the opposite apparatus is controlled, the recovery management unit 46 sets an IKE packet parameter, activates the key exchange unit 44, and negotiates (transmits and receives) an IKE packet. In a case in which an IKE packet for recovery (an instruction of the recovery method) is received from the opposite apparatus, the recovery management unit 46 executes a recovery process according to the recovery method in response to the instruction. Further, the recovery management unit 46 updates the recovery state and switches the recovery method to be executed.

The upper layer processing unit 47 executes signal conversion for the purpose of wireless communication. The upper layer processing unit 47 terminates a protocol of the upper layer of the IPsec. Examples of the protocol of the upper layer include an internet control message protocol (ICMP), a stream control transmission protocol (SCTP), and a GPRS tunneling protocol for user plane (GTP-U). However, the protocol of the upper layer is not limited to these protocols. The protocol of the upper layer terminated by the apparatus is different for each apparatus including the upper layer processing unit 47 in some cases.

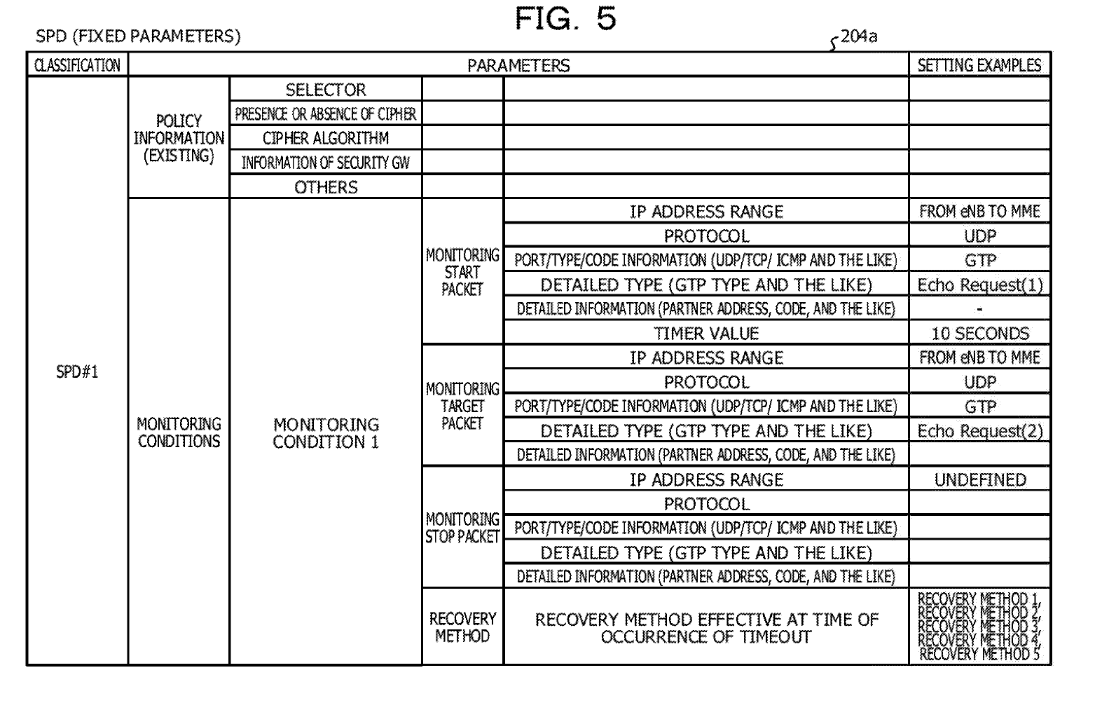

FIGS. 5, 6, and 7 are diagrams illustrating an example of the data structure of the SPD 204a stored in the memory 204. Fixed parameters (information) are registered in the SPD 204a. In the SPD 204a, information elements of the monitoring conditions and the recovery methods are registered in addition to information elements used to establish the IPsec_SA of the related art. The information elements of the monitoring conditions and the recovery methods include a plurality of proposals (which are examples of candidates called “proposals”) in the monitoring conditions and the recovery methods. Of the plurality of proposals (candidates), proposals (monitoring conditions and recovery methods) which can be handled by a negotiation destination (responder) are adopted (selected).

The monitoring conditions included in negotiation packets can include candidates of a plurality of monitoring start packets and a plurality of monitoring target packets. In a case in which the plurality of monitoring start packets and the plurality of monitoring target packets are agreed, monitoring is executed in parallel using the plurality of monitoring start packets and the plurality of monitoring target packets. Conversely, in a case in which abnormality is detected, one of the plurality of agreed recovery methods is executed according to priority.

As illustrated in FIGS. 5, 6, and 7, policy information, one or more monitoring conditions 1 to n (where n is an integer equal to or greater than 1), and one or more policy methods 1 to m (where m is an integer equal to or greater than 1) corresponding to classification (SPD numbers: SPD #1 to #x (where x is an integer equal to or greater than 1)) are registered in the SPD 204a. The monitoring conditions 1 to n are examples of “a plurality of candidates of the monitoring target packet” and the recovery methods 1 to m are examples of “a plurality of candidates of the recovery method”.

As illustrated in FIG. 5, the selector, presence or absence of a cipher, a cipher algorithm, and security GW (secGW) information are registered as the policy information.

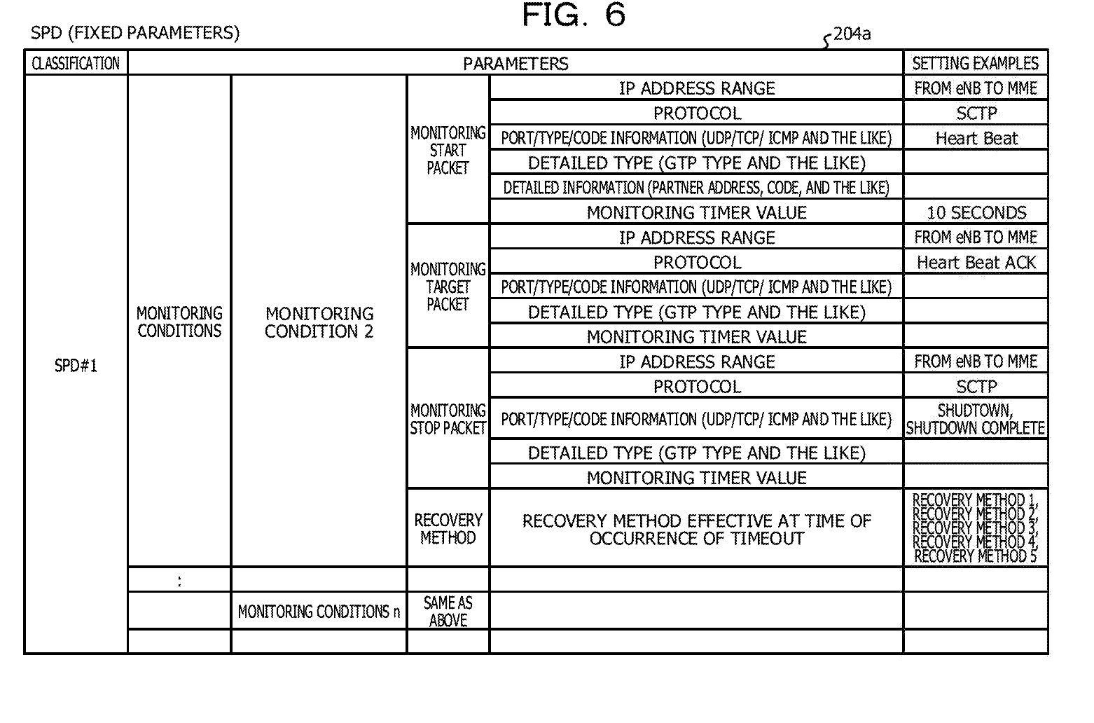

As the monitoring conditions, as illustrated in FIGS. 5 and 6, information for specifying the monitoring start packet, the monitoring target packet, the monitoring stop packet, and the recovery method is registered for each monitoring condition number. Information items for specifying the monitoring start packet include, for example, an IP address range, a protocol, a port, a type, and code information (UDP/TCP/ICMP, and the like), information regarding a detailed type (GTP type), detail information (a partner address, a code, and the like). Further, a monitoring timer value is registered in association with the information for specifying the monitoring start packet. The monitoring timer value defines a predetermined time clocked at the time of reception of the monitoring start packet.

As in the monitoring start packet, information items for specifying the monitoring target packet and the monitoring stop packet include an IP address range, a protocol, a port, a type, and code information, information regarding a detailed type, detail information. The monitoring stop packet is a packet for stopping the monitoring using reception of the monitoring stop packet as an opportunity. In this way, by commonly using the information items (using the common information items), it is possible to reduce an information amount of management targets, commonly use an algorithm handling information, simplify the configuration, and thus suppress an increase in a processing load. As the recovery method, information for specifying the recovery method selected at the time of detection of abnormality based on the monitoring target packet is registered.

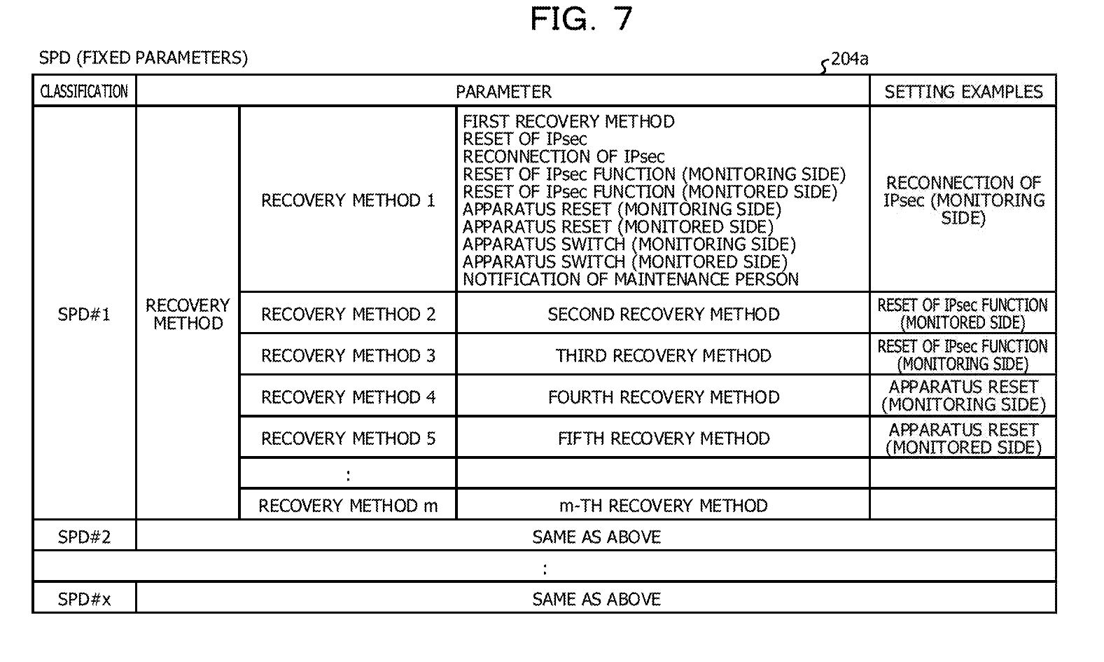

As illustrated in FIG. 7, as the recovery method, a plurality of candidates of the recovery method are registered in association with recovery method numbers in order of the priority. For example, the following candidates are registered as examples of the first recovery method:
reset of the IPsec;
reconnection of the IPsec;
reset of an IPsec function (monitoring side);
reset of an IPsec function (monitored side);
apparatus reset (monitoring side);
apparatus reset (monitored side);
apparatus switch (monitoring side);
apparatus switch (monitored side); and
notification of maintenance person.

Information (including parameters) related to the IPsec agreed in the negotiation of the establishment of the IPsec_SA is registered in the SA 204b illustrated in FIG. 4. The information regarding the IPsec_SA registered in the SA 204b is shared between the base station 2 and the secGW 3.

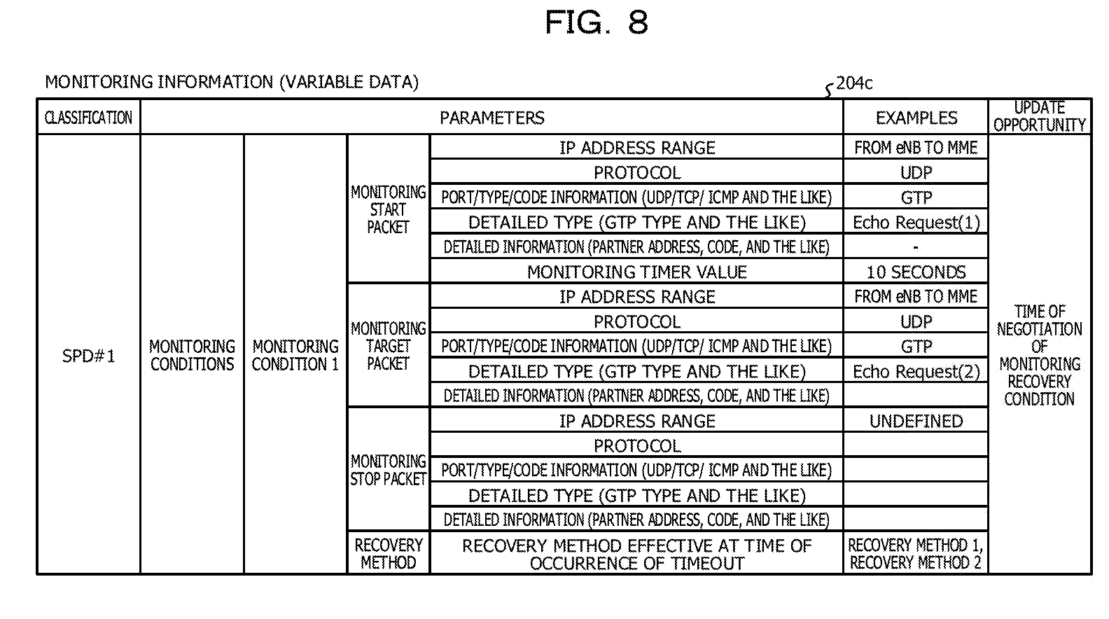

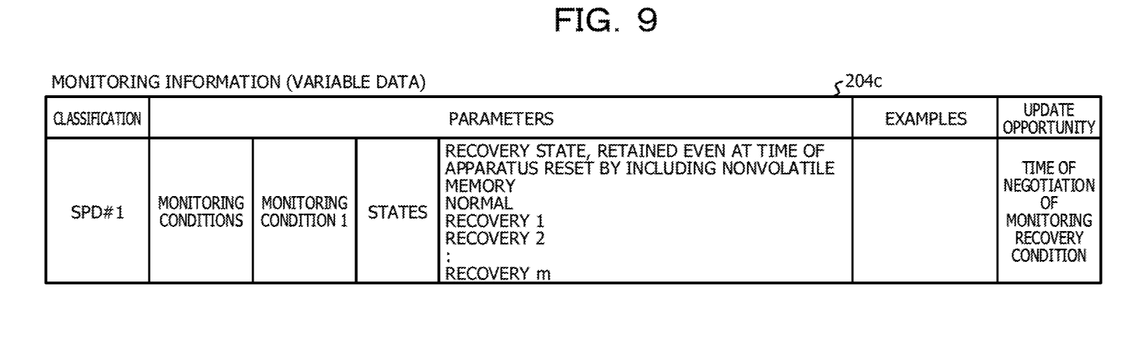

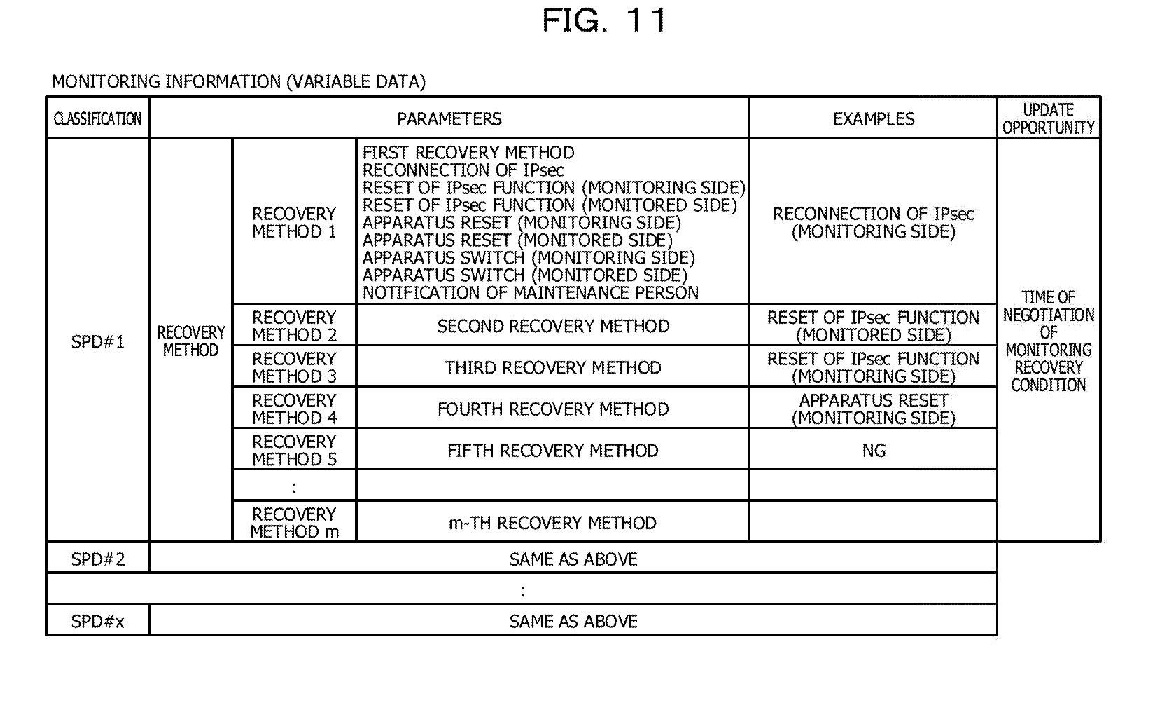

FIGS. 8, 9, 10, and 11 illustrate a data structure example of the monitoring information 204c. Of the information related to the establishment of the IPsec_SA, the monitoring condition, and the recovery method registered in the SPD 204a, information agreed (shared) between termination apparatuses (peers) of the IPsec_SA in such negotiation are registered in the monitoring information 204c.

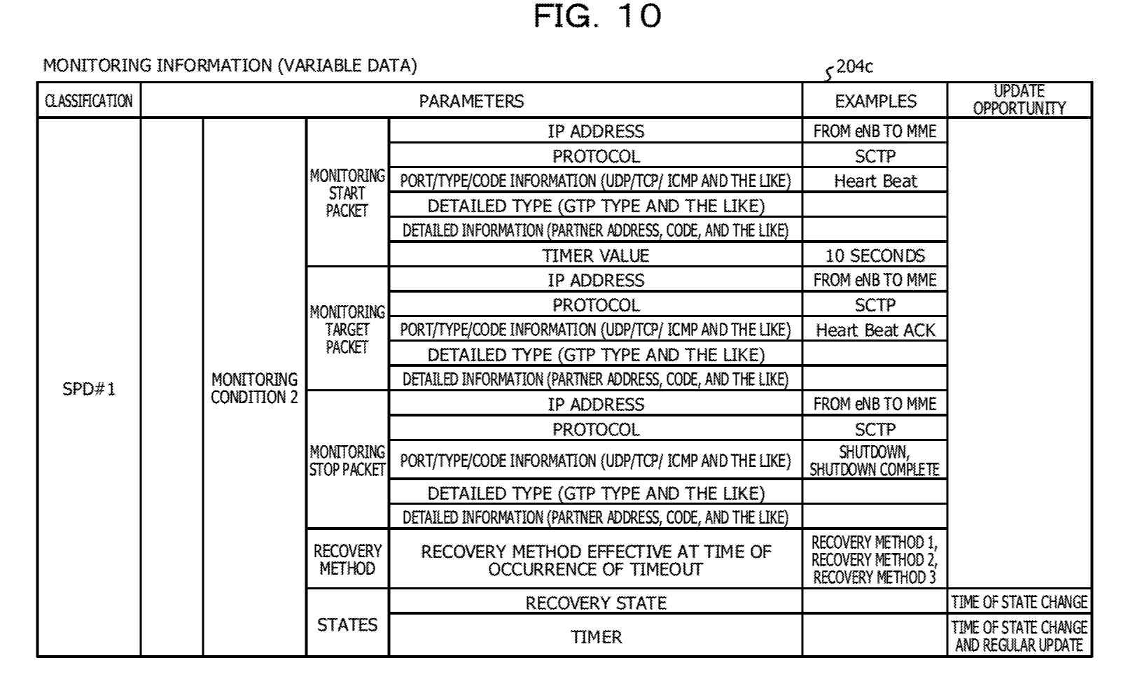

As illustrated in FIG. 10, information indicating “normal”→“recovery 1”→“recovery 2”→ . . . “recovery m” is stored as information indicating a recovery state. A recovery method according to a state indicating the recovery state is selected and executed. The information indicating the recovery state is updated at the time of reception of an instruction to update the recovery state.

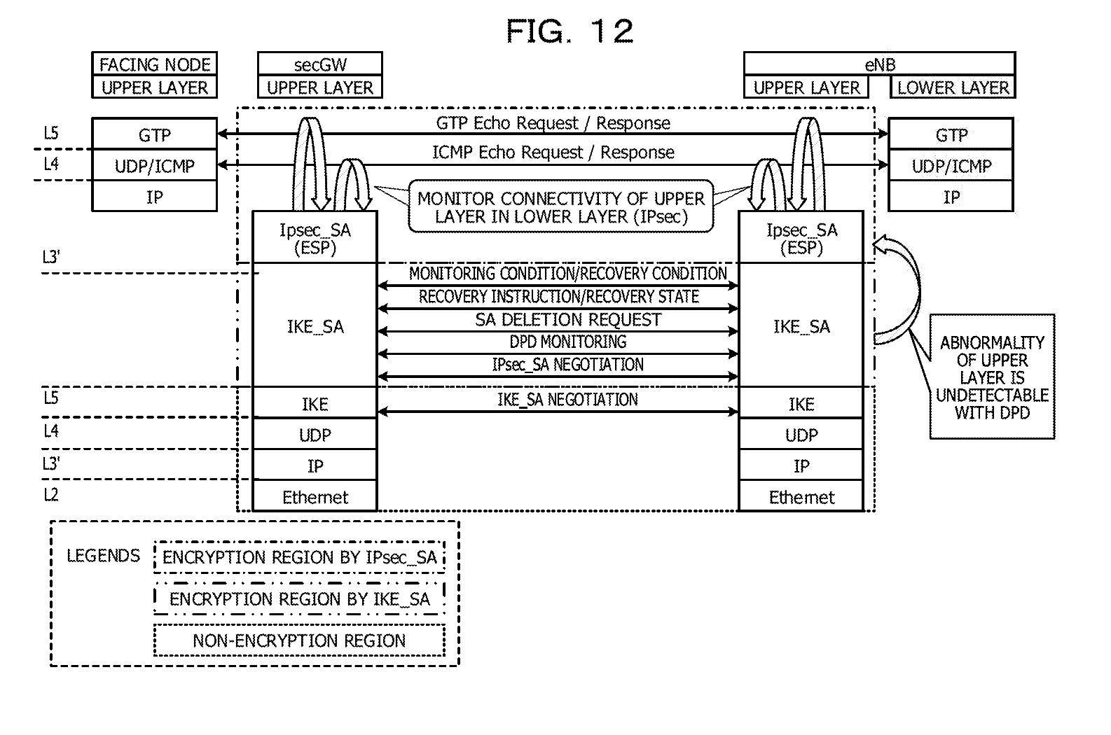

FIG. 12 is an explanatory diagram illustrating a protocol stack according to the embodiment. In the example of FIG. 12, a packet for which an upper layer is a GTP is transmitted and received between a base station (eNB) and a opposite node. A protocol stack of the GTP packet has the GTP (L5), an UDP/ICMP (L4), and an IP (L3).

The GTP packet is encrypted with the IPsec_SA (ESP) between the secGW 3 and the base station 2. The IKE_SA is located below the IPsec_SA. In the IKE_SA, negotiation of the IPsec_SA, a DPD, an SA deletion request, a recovery method instruction/recovery state update instruction, and a monitoring condition/recovery method are transmitted and received using the IKE packet. The IKE packet is encrypted using the IKE_SA.

An IKE (L5), a UDP (L4), an IP (L3), and an Ethernet® (L2) are located below the IKE_SA. These are non-encryption regions.

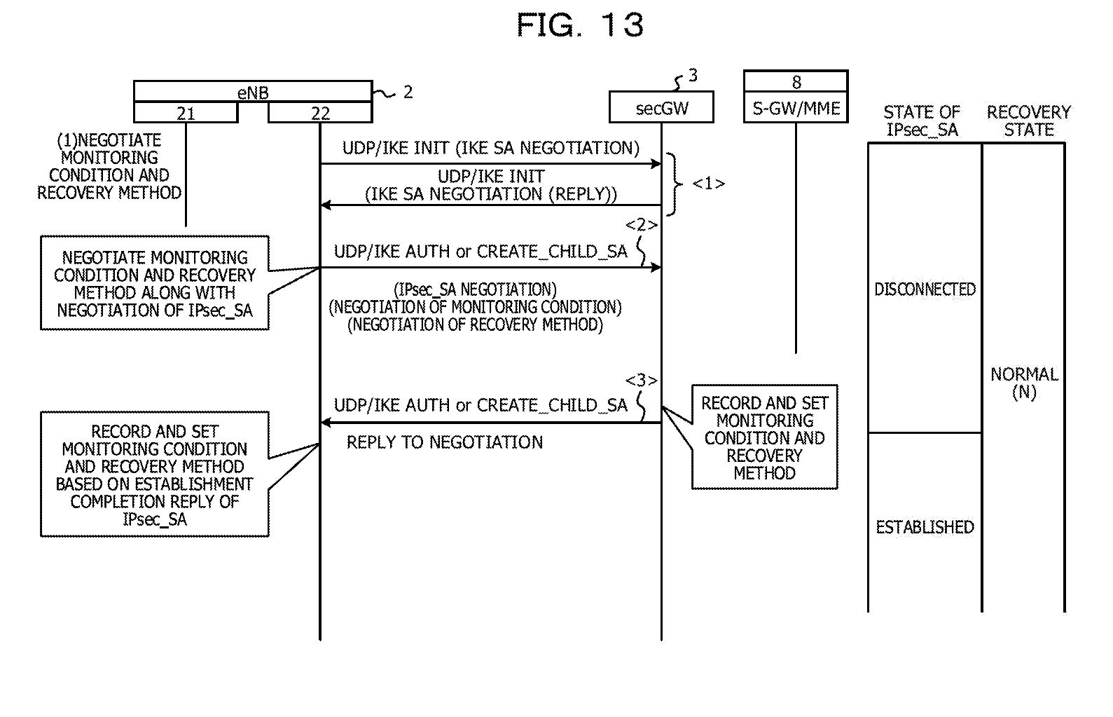

FIGS. 13, 14, 15, 16, and 17 are sequence diagrams illustrating operation examples according to the embodiment. Abnormality detection methods and recovery methods according to the embodiment will be described using the operation examples illustrated in FIGS. 13 to 17.

FIG. 13 illustrates an operation example related to negotiation of the monitoring condition and the recovery method. The base station (eNB) 2 includes a protocol termination unit 21 and an IPsec unit 22. The protocol termination unit 21 and the IPsec unit 22 are, for example, functions of the processor 203 obtained by executing a program.

The IPsec unit 22 of the base station 2 transmits a message (UDP/IKE INIT message) related to the negotiation of the IKE_SA to the secGW 3. The secGW 3 returns the UDP/IKE INIT message to the base station 2 (see <1> in FIG. 13). Accordingly, the IKE_SA is established.

When the IKE_SA is established, the IPsec unit 22 transmits a packet (negotiation packet) including a message for the negotiation of the IPsec_SA to the secGW 3 (<2> in FIG. 13). For example, an UDP/IKE_AUTH message or a CREATE_CHILD_SA message in the IPsec is used as the message for the negotiation of the IPsec_SA.

In the IKE in the operation example, IKEv2 (IKE version 2) is applied. In IKEv2, the IPsec_SA is called CHILD_SA. Of course, IKEv1 may be applied instead of IKEv2. In IKEv1, the IKE_SA is called an internet security association and key management protocol_Security Association (ISAKMP_SA).

The negotiation packet includes not only a proposal parameter (proposal) related to the negotiation of the IPsec_SA but also proposal parameters of the monitoring conditions and the recovery methods. For example, the proposal parameters are as follows.

Monitoring Conditions
Proposal 1: monitoring condition 1
Proposal 2: monitoring condition 2

Recovery Methods
Proposal 1: re-establishment of the IPsec (monitoring side)
Proposal 2: reset of the IP sect unit (monitoring side)
Proposal 3: reset of the IP sect unit (monitored side)
Proposal 4: apparatus reset (monitoring side)
Proposal 5: apparatus reset (monitored side)

When the negotiation packet is received, the secGW 3 executes an IPsec establishment process using the proposal parameters related to the negotiation of the IPsec_SA. The secGW 3 extracts the proposal which can be supported by the secGW 3 among the proposal parameters of the monitoring conditions and the recovery methods and registers the extracted proposal in the monitoring information 203c. The secGW 3 transmits a reply message including the proposal registered in the monitoring information 203c to the base station 2 (<3> in FIG. 13).

For example, the secGW 3 to be monitored does not support the apparatus reset. Therefore, the monitoring conditions and the recovery methods registered in the monitoring information 204c of the secGW 3 are as follows.

Monitoring Conditions
Proposal 1: monitoring condition 1
Proposal 2: monitoring condition 2

Recovery Methods
Proposal 1: re-establishment of the IPsec (monitoring side)
Proposal 2: reset of the IP sect unit (monitoring side)
Proposal 3: reset of the IP sect unit (monitored side)
Proposal 4: apparatus reset (monitoring side)

The IPsec unit 22 of the base station 2 completes the establishment of the IPsec_SA at the time of reception of the reply message and stores the proposals of the monitoring conditions and the recovery methods which can be executed by the opposite apparatus (the secGW 3) in the monitoring information 204c based on the reply result. Accordingly, the IPsec_SA, the monitoring conditions, and the recovery methods are shared between the base station 2 and the secGW 3.

Even when the opposite apparatus (responder) replies to all of the proposals as NG in the reply result of the opposite apparatus in the reply message, the monitoring conditions and the recovery methods which can be executed on the monitoring side (initiator) are stored in the monitoring information 204c to execute the monitoring and recovery methods.

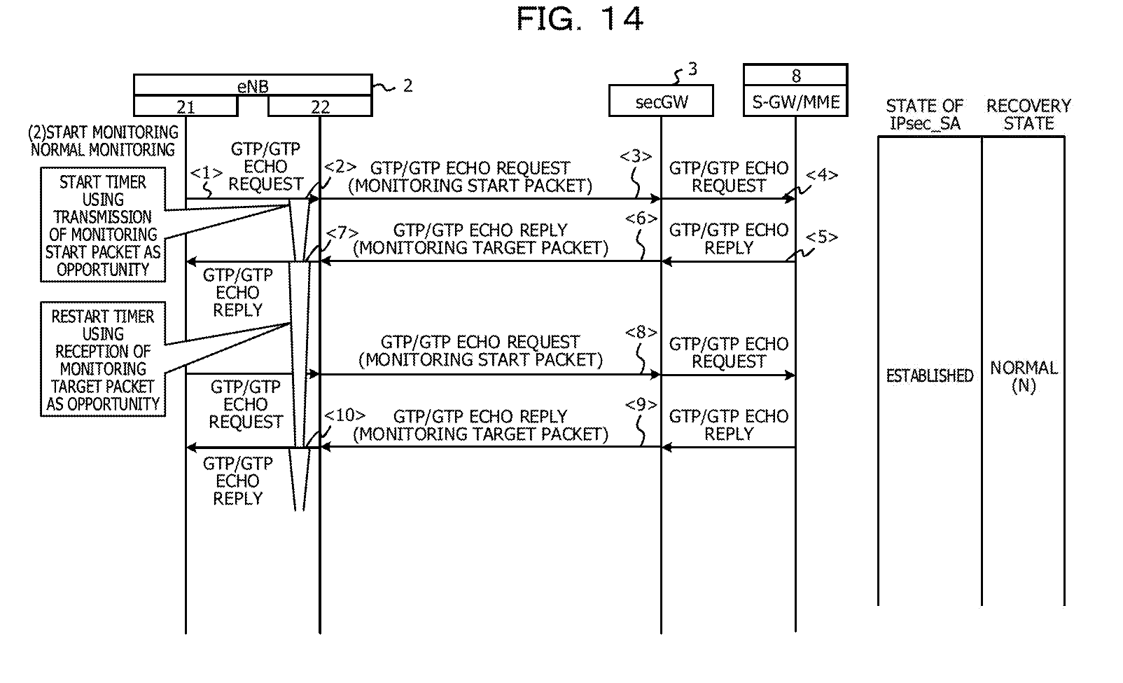

FIG. 14 is a sequence diagram illustrating an operation example of normal monitoring from monitoring start. In FIG. 14, the protocol termination unit 21 of the base station 2 transitions the monitoring state to “monitoring” when receiving the monitoring start packet decided in the negotiation (<1> in FIG. 14). The monitoring start packet is, for example, a GTP/GTP echo request. Further, the protocol termination unit 21 starts clocking of the monitoring timer using the reception of the monitoring start packet as an opportunity (<2> in FIG. 14).

The IPsec unit 22 transmits an encrypted packet (ESP/GTP/GTP echo request) generated by executing the encryption of the IPsec on the monitoring start packet to the secGW 3 (<3> in FIG. 14).

The secGW 3 decrypts the encrypted packet and transmits the obtained original monitoring target packet (GTP/GTP echo request) to the core network 8 (<4> in FIG. 14). The core network 8 (one of the MME 4 and the S-GW 5, for example, the MME 4) transmits a reply packet (GTP/GTP echo reply) to the monitoring start packet (<5> in FIG. 14). The reply packet is encrypted by the secGW 3 and the encrypted reply packet (ESP/GTP/GTP echo reply) is transmitted to the base station 2 (<6> in FIG. 14).

The IPsec unit 22 of the base station 2 restarts the monitoring timer using the reception of the monitoring target packet as an opportunity since the received encrypted reply packet is the monitoring target packet (<7> in FIG. 14). The encrypted reply packet is decrypted and the original reply packet (GTP/GTP echo reply) is transmitted to the protocol termination unit 21.

The monitoring start packet (ESP/GTP/GTP echo request) is transmitted from the IPsec unit 22 of the base station 2 to the secGW 3 (<8> in FIG. 14). The monitoring target packet (ESP/GTP/GTP echo reply) which is a reply packet to the monitoring start packet is received by the secGW 3 (<9> in FIG. 14). The IPsec unit 22 of the base station 2 restarts the monitoring timer using the reception of the monitoring target packet as an opportunity (<10> in FIG. 14). In this way, the IPsec unit 22 of the base station 2 starts clocking the monitoring timer using the reception of the monitoring start packet (echo request) as an opportunity and restarts the monitoring timer whenever the monitoring target packet (echo reply) is received. In this way, the monitoring target packet is monitored.

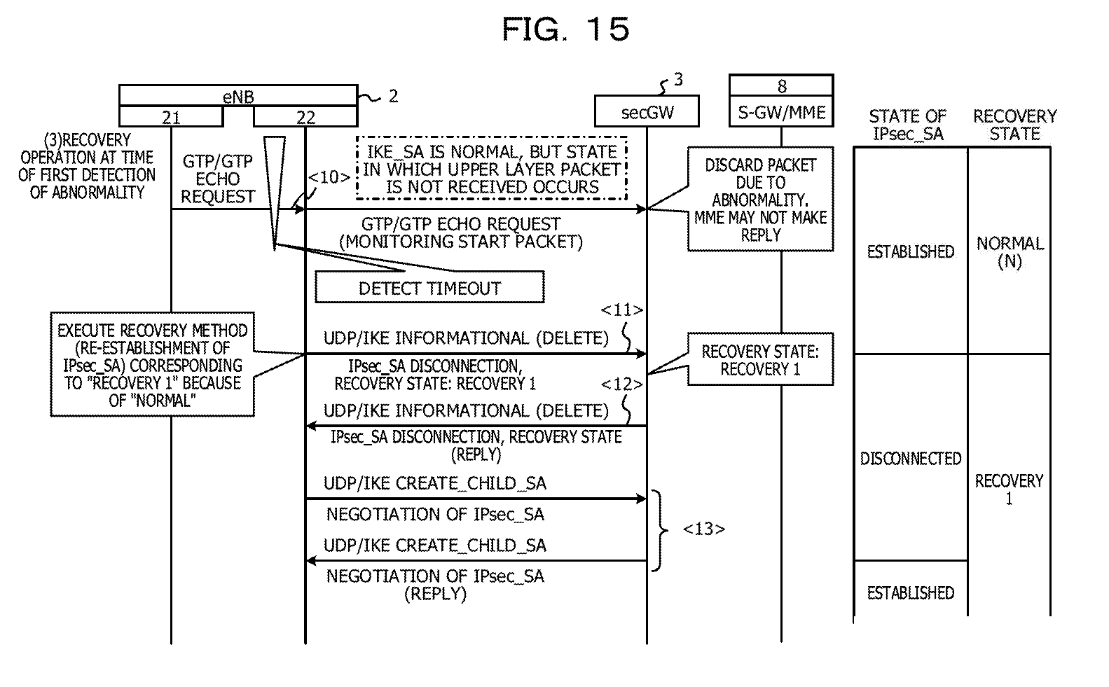

FIG. 15 illustrates a continuous operation of <10> of FIG. 14. After the monitoring timer is restarted and the monitoring start packet (ESP/GTP/GTP echo request) is transmitted to the secGW 3, but abnormality is assumed to occur in the IPsec_SA. Further, it is assumed that the monitoring start packet is not normally decrypted and the monitoring start packet is discarded. In this case, the MME 4 of the core network 8 may not transmit the monitoring target packet (reply packet). Accordingly, the monitoring timer times out.

Then, the IPsec unit 22 of the base station 2 determines disconnection of the IPsec_SA. The recovery state “normal” of the monitoring information 204c is transitioned to “recovery 1” and the recovery method “re-establishment of the IPsec (monitoring side)” corresponding to recovery 1 is executed. That is, the IPsec unit 22 transmits a disconnection request message (UDP/IKE INFORMATIONAL (DELETE)) of the IPsec_SA to the secGW 3 (<11> in FIG. 15).

The secGW 3 receives a disconnection request message and transitions the recovery state of monitoring condition 1 to recovery 1. The secGW 3 returns the reply message of the disconnection request message (<12> in FIG. 15). Thereafter, the base station 2 and the secGW 3 execute an order (message exchange) of the re-establishment of the IPsec_SA and re-establishes the IPsec_SA (<13> in FIG. 15).

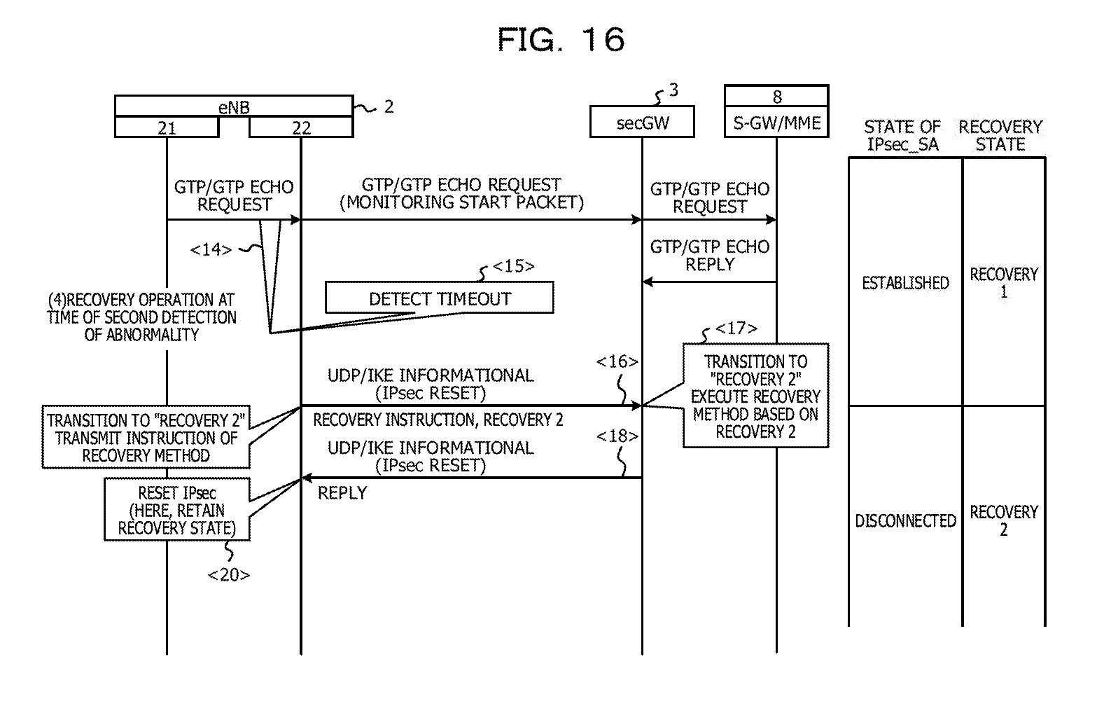

FIG. 16 illustrates a continuous operation of <13> of FIG. 15. In a case in which the monitoring start packet (echo request) is received, the IPsec unit 22 of the base station 2 starts clocking the monitoring timer (<14> in FIG. 16).

In a case in which the monitoring target packet (echo reply) is not received before expiration of the monitoring timer, the IPsec unit 22 transitions the recovery state from current “recovery 1” to subsequent “recovery 2” (<15> in FIG. 16). The IPsec unit 22 transmits a message (UDP/IKE INFORMATIONAL (IPsec function reset)) including an instruction of the recovery method corresponding to “recovery 2” to the secGW 3 (<16> of FIG. 15).

The secGW 3 transitions the recovery state to “recovery 2” according to the message of the instruction of the recovery method and executes the reset of the IPsec function which is the recovery method corresponding to recovery 2 (<17> of FIG. 16).

The secGW 3 transmits a reply message to the message of the instruction of the recovery method to the base station 2 (<18> in FIG. 16). The IPsec unit 22 of the base station 2 executes the reset of the IPsec function (<19> in FIG. 16). The reset of the recovery state is not executed.

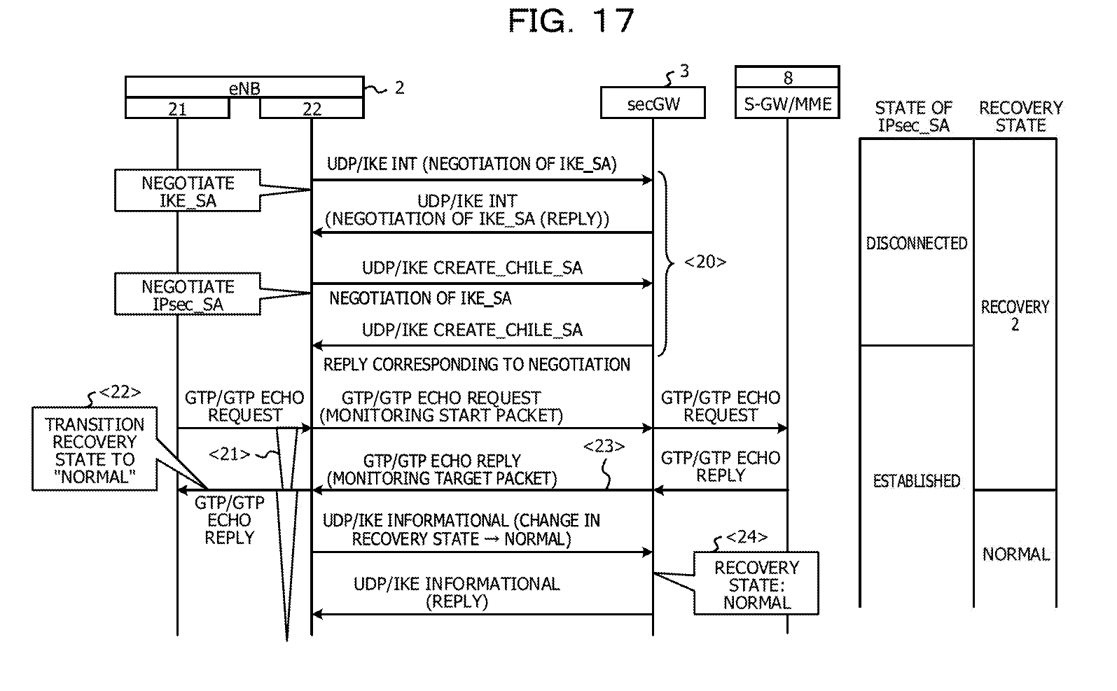

FIG. 17 illustrates a continuous operation of <19> of FIG. 16. In FIG. 17, negotiation related to the re-establishment of the IKE_SA and the IPsec_SA is executed between the base station 2 and the secGW 3 using the reset of the IPsec function as an opportunity to establish the IKE_SA and the IPsec_SA (<20> of FIG. 17). At this time, as described above, the negotiation and agreement of the monitoring conditions and the recovery methods are executed.

Thereafter, the base station 2 starts clocking the monitoring timer using the reception of the monitoring start packet as an opportunity (<21> in FIG. 17). When the monitoring target packet is received in the base station 2, the IPsec unit 22 updates the recovery state from “recovery 2” to “normal” (<22> in FIG. 17). The IPsec unit 22 transmits a message of an instruction to update the recovery state to the secGW 3 (<23> in FIG. 17). The secGW 3 updates the recovery state from “recovery 2” to “normal” according to the message of the instruction to update the recovery state (<24> in FIG. 17).

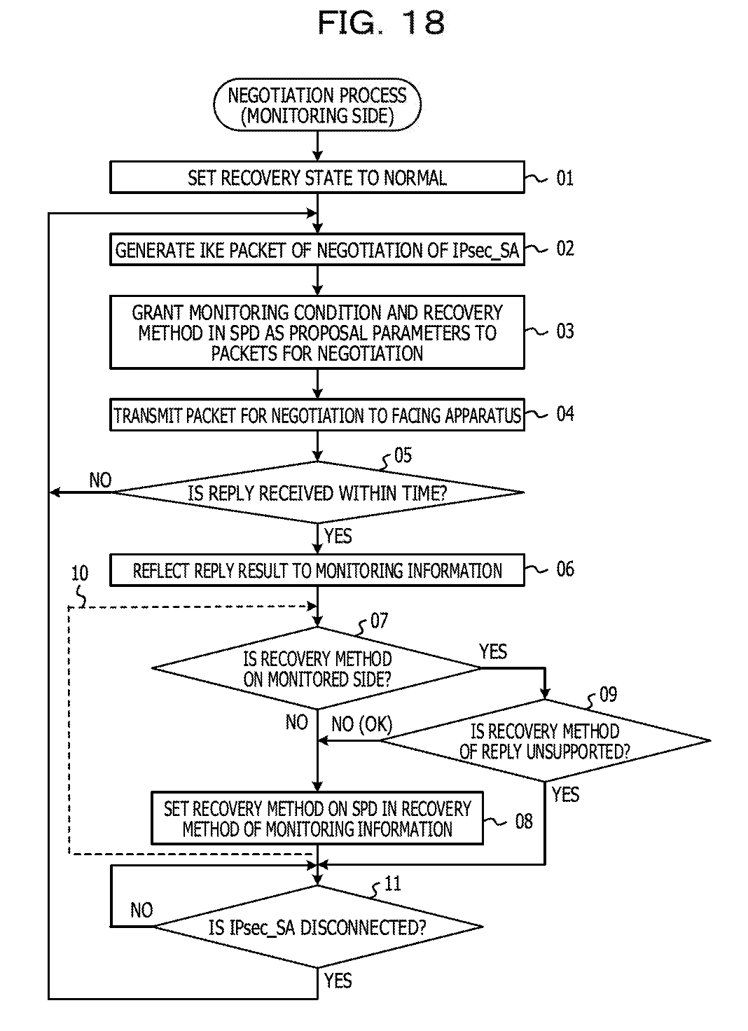

Next, a processing example of the base station 2 and the secGW 3 will be described with reference to flowcharts. Processes of the flowcharts of FIGS. 18 to 23 to be described below are executed, for example, when the processor 203 executes a program.

FIG. 18 is a flowchart illustrating an example of a negotiation process (monitoring side). The process of FIG. 18 is executed by, for example, the processor 203 operating as the control unit 202 (303) that executes a process of an initiator in the IPsec. However, the responder serves as the monitoring side in some cases. The process of FIG. 18 starts, for example, at the time of power-up.

In the process of 01, the processor 203 sets the recovery state to “normal”. Initialization is executed at the time of power-up so that the recovery state is not initialized at the time of reset of the IPsec function.

In the process of 02, the processor 203 generates an IKE packet (negotiation packet) for the negotiation of the IPsec_SA. The negotiation packet includes a proposal related to the establishment of the IPsec_SA.

In the process of 03, the processor 203 includes the proposal of the monitoring condition and the recovery method in the SPD 204a stored in the memory 204 in the negotiation packet. In the process of 04, the processor 203 transmits the negotiation packet to the opposite apparatus (responder). After transmitting the negotiation packet, the processor 203 enters a reply standby state of the reply packet for a predetermined time (a standby time of the standby timer). The reply packet is an IKE packet for a reply to the negotiation packet.

In the process of 05, the processor 203 determines whether the reply packet is received before the predetermined time elapses (before the standby timer expires). In a case in which the reply is received (Yes of 05), the process proceeds to 06. Conversely, in a case in which the reply is not received (No of 05), the process returns to 02. In a case in which the reply is not received, the negotiation is treated as a failure. In a case in which the replay is received, the negotiation is treated as a success.

In the process of 06, the processor 203 reflects (registers) the reply result included in the reply, that is, information regarding the IPsec_SA, the monitoring condition, and the recovery method agreed by the opposite apparatus (selected from the proposal by the opposite apparatus) to the monitoring information 204c of the memory 204.

In the process of 07, the processor 203 determines whether the recovery method is on the “monitored side”. That is, the processor 203 determines whether a side to which an apparatus including the processor 203 belongs is the “monitored side” in the recovery method. For example, the initiator of the IPsec is set in advance to serve as the monitoring side and the responder is set in advance to serve as the monitored side. In this case, the determination of 07 can be executed depending on whether the own apparatus is the initiator or the responder. In a case in which the recovery method is on the monitored side (Yes of 07), the process proceeds to 09. Conversely, in a case in which the recovery method is on the monitored side (No of 07), the process proceeds to 08.

In the process of 08, the processor 203 sets the recovery method on the SPD 204a in accordance with the recovery method in the monitoring information 204c. The process of 08 is treated in a case in which the apparatus including the processor 203 is the monitoring side.

In the process of 09, the processor 203 determines whether the recovery method of the reply is unsupported on the monitored side. In a case in which the recovery method is unsupported (No of 09), the process proceeds to 08. In a case in which the recovery method is supported (Yes of 09), the process proceeds to 11. The process of 09 is treated in a case in which the apparatus including the processor 203 is the monitored side.

A dotted line 10 illustrated in FIG. 18 indicates that the processes 07, 08, and 09 are repeated by the same number of times as the number of elements indicating the recovery methods registered in the SPD 204a. When the processes 07 to 09 related to the recovery methods end, the process proceeds to 11.

In the process of 11, the processor 203 determines whether the IPsec_SA is disconnected (whether the abnormality occurs). In a case in which the IPsec is disconnected (Yes of 11), the process returns to 02 and the negotiation related to the re-establishment of the IPsec_SA is executed.

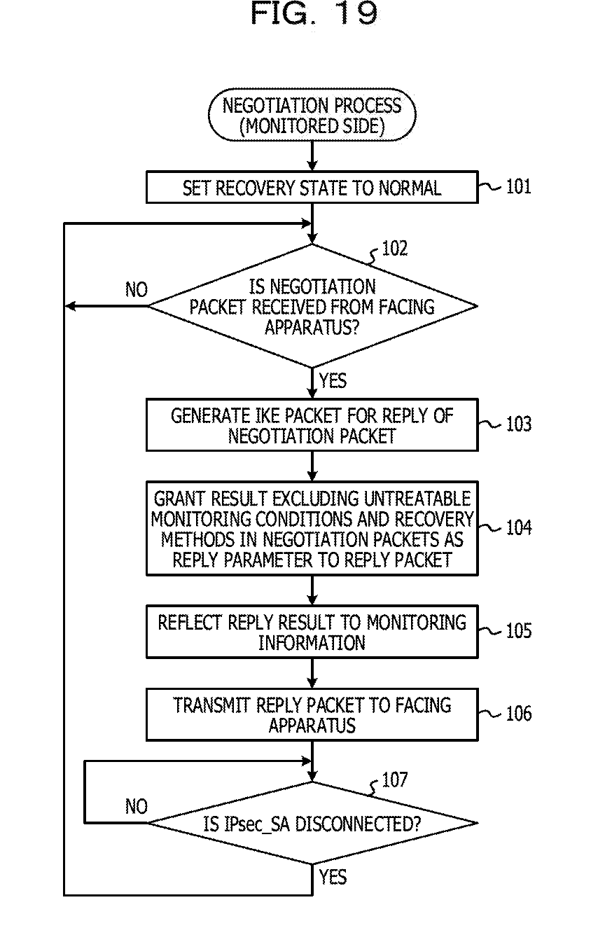

FIG. 19 is a flowchart illustrating an example of a negotiation process (monitored side). The process of FIG. 19 is executed by, for example, the processor 203 operating as the control unit 202 (303) that executes a process of a responder in the IPsec. However, the initiator serves as the monitored side in some cases. The process of FIG. 19 starts, for example, at the time of power-up.

In the process of 101, the processor 203 sets the recovery state to “normal”. In the process of 102, the processor 203 determines whether the IKE packet (negotiation packet) for the negotiation of the IPsec_SA is received from the opposite apparatus (from the initiator). In a case in which the negotiation packet is received (Yes of 102), the process proceeds to 103.

In the process of 103, the processor 203 generates the IKE packet (reply packet) for a reply of the negotiation packet. In the process of 104, the processor 203 includes a result excluding the monitoring conditions and the recovery methods (of NG) untreatable by the responder among the monitoring conditions and the recovery methods in the negotiation packet to the reply packet as a reply parameter. In this way, the monitoring conditions and the recovery methods agreed by the monitored side among the proposals from the monitoring side are selected.

In the process of 105, the processor 203 reflects (registers) the reply result (reply parameter) to the monitoring information 204c of the memory 204. In the process of 106, the processor 203 transmits the reply packet to the opposite apparatus.

In the process of 107, the processor 203 monitors the IPsec_SA to determine whether the IPsec_SA is disconnected (whether there is abnormality). In a case in which the IPsec_SA is disconnected (Yes of 107), the process returns to 102 and the negotiation related to the re-establishment of the IPsec_SA is executed.

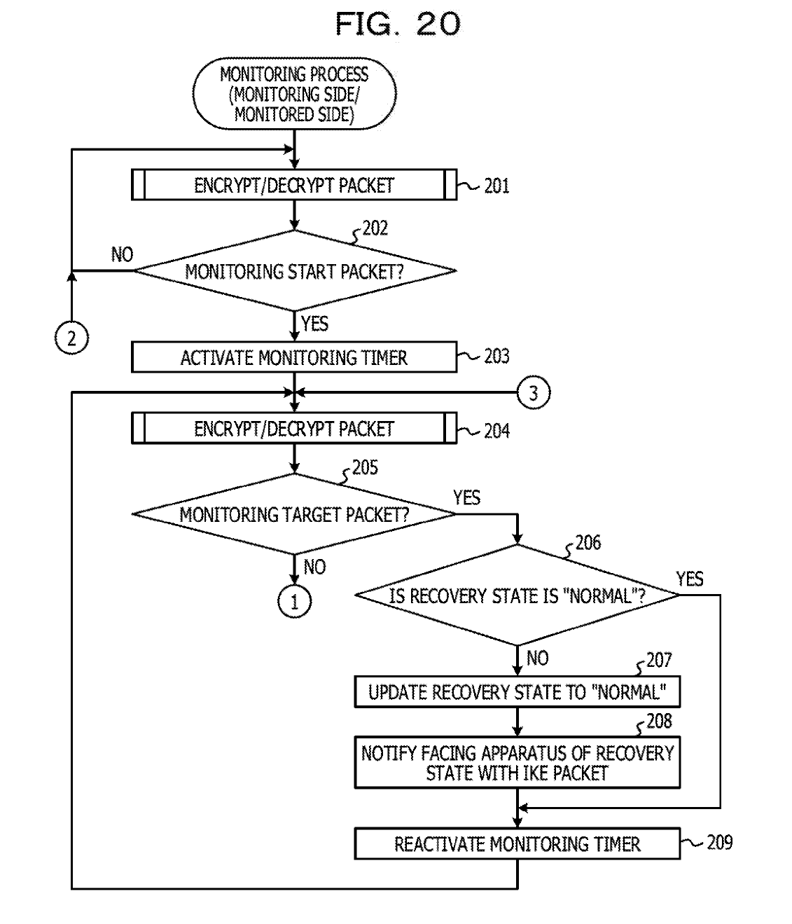

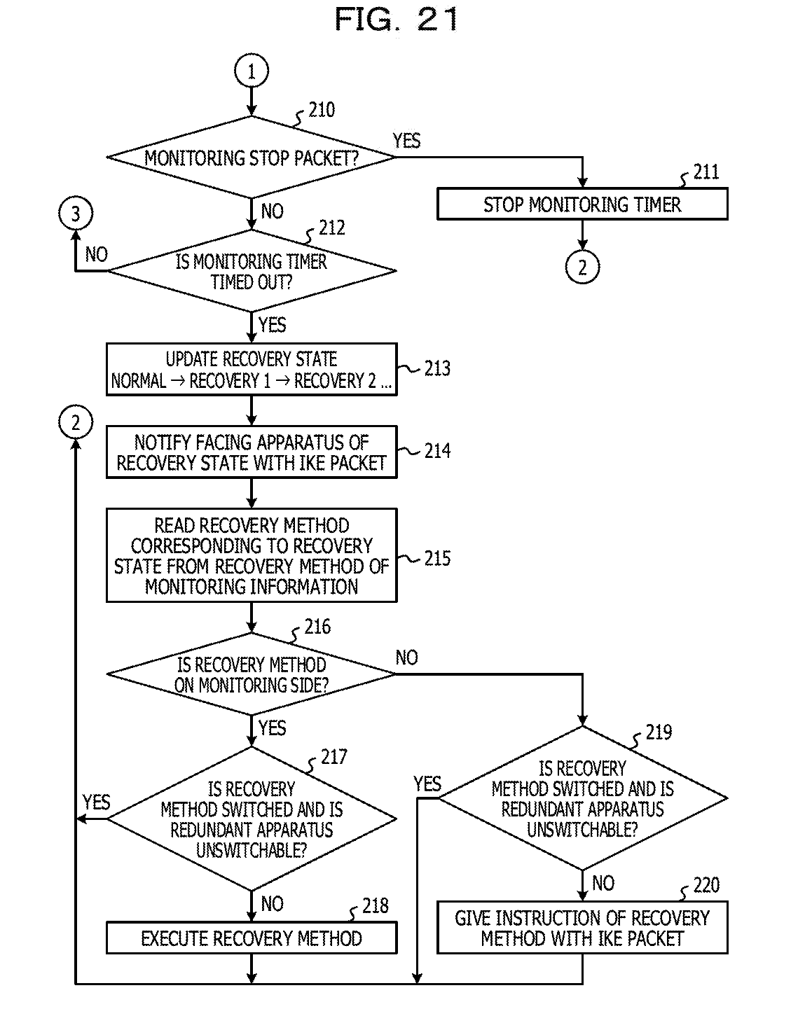

FIGS. 20 and 21 are flowcharts illustrating an example of a negotiation process. Content of the monitoring process can be set to be the same between the monitoring side and the monitored side. However, the content may be different between the both sides. The processes of FIGS. 20 and 21 are performed by, for example, the processor 203 operating as the control unit 202 (303). The processes of FIGS. 20 and 21 start, for example, using establishment of the IPsec_SA as an opportunity.

In the process of 201, the processor 203 executes an encryption/decryption process on a received packet. In a termination process for the IPsec_SA, an apparatus transmitting an encrypted packet of the IPsec executes an encryption and encapsulation process on the packet as a packet encryption/decryption process using the ESP. Conversely, an apparatus receiving the encrypted packet of the IPsec executes decapsulation and decryption on the encrypted packet as a packet encryption/decryption process.

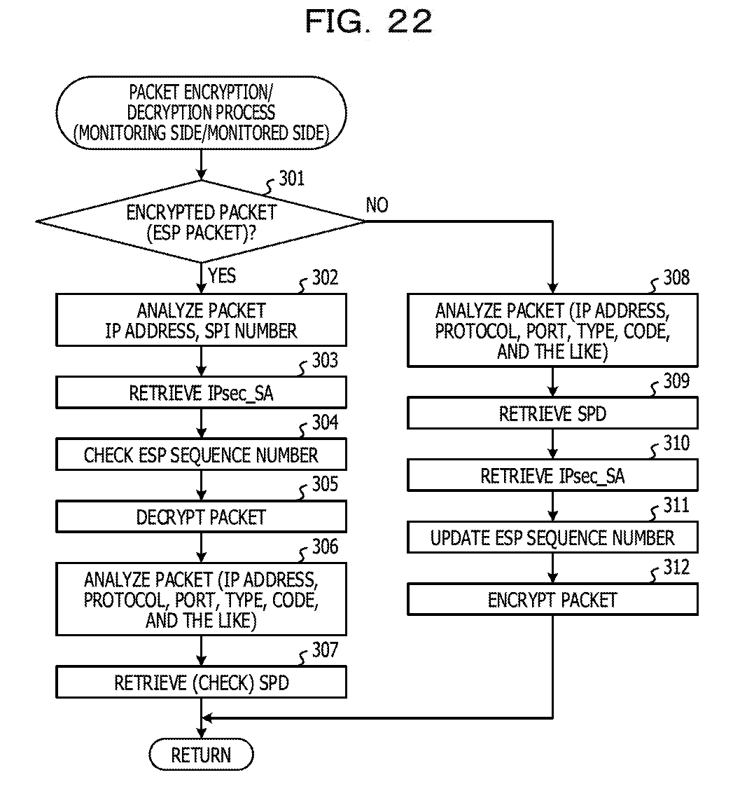

FIG. 22 is a flowchart illustrating an example of a packet encryption/decryption process (subroutine). In the process of 301, the processor 203 determines whether the received packet is an encrypted packet (the packet encrypted and encapsulated based on the ESP: an ESP packet). When the received packet is the encrypted packet (Yes of 301), the process proceeds to 302. Otherwise (No of 301), the process proceeds to 308.

In the process of 302, the processor 203 analyzes the encrypted packet to obtain an IP address (at least one of a transmission source and a destination) and a security parameter index (SPI) of the encrypted packet. The SPI is 32-bit ID information indicating the SA to which the own apparatus belongs.

In the process of 303, the processor 203 retrieves the IPsec_SA related to the encrypted packet from the SA 204b of the memory 204 using the IP address and the SPI obtained from 302. In the process of 304, the processor 203 checks an ESP sequence number of the encrypted packet.

In the process of 305, the processor 203 executes a decryption process (decapsulation and decryption) on the encrypted packet. In the process of 306, the processor 203 analyzes the decapsulated packet. By analyzing the decapsulated packet, parameters included in the packet, such as the IP address, the protocol, the port number, the type, the code of the packet, are obtained. In the process of 307, the processor 203 retrieves the SPD 204a using the parameters obtained in the process of 306.

In the process of 308, the processor 203 analyzes the packet. By analyzing the packet, parameters included in the packet, such as the IP address, the protocol, the port number, the type, the code of the packet, are obtained. In the process of 309, the SPD 204a is obtained using the parameters obtained in the process of 308.

In the process of 310, the processor 203 retrieves the IPsec_SA. In the process of 311, the processor 203 updates the ESP sequence number. In the process of 312, the processor 203 encrypts and encapsulates the packet based on the ESP.

The process returns (comes back) to 202 of FIG. 19 and the processor 203 determines whether the received packet is the monitoring start packet. This process is determined according to whether the parameters obtained from the packet satisfy the monitoring conditions included in the monitoring information 204c. When the packet is the monitoring start packet (Yes of 202), the process proceeds to 203. Otherwise (No of 202), the process proceeds to 210.

In the process of 203, the processor 203 activates the monitoring timer. Thereafter, when the packet is received, the processor 203 executes the packet encryption/description process (see FIG. 22) (process of 204). In the process of 205, the processor 203 determines whether the received packet is the monitoring target packet. When the packet is the monitoring target packet (Yes of 205), the process proceeds to 206. Otherwise (No of 205), the process returns to 201.

In the process of 206, the processor 203 determines whether the recovery state is “normal” with reference to the monitoring information 204c. At this time, when the recovery state is “normal” (Yes of 206), the process proceeds to 209. Otherwise (No of 206), the process proceeds to 207.

In the process of 207, the processor 203 updates the recovery state to “normal”. In the process of 208, the processor 203 notifies the opposite apparatus of the updated recovery state using the IKE packet (gives an instruction to update the recovery state). In the process of 209, the processor 203 reactivates the monitoring timer.

In the process of 210, the processor 203 determines whether the received packet is the monitoring stop packet. When the packet is the monitoring stop packet (Yes of 210), the process proceeds to 211. Otherwise (No of 210), the process proceeds to 212. In the process of 211, the processor 203 stops the monitoring timer and returns the process to 201.

In the process of 212, the processor 203 determines whether the monitoring timer times out (expires). In a case in which the monitoring timer times out (expires) (Yes of 212), the process proceeds to 213. Conversely, in a case in which the monitoring timer does not time out (does not expire) (No of 212), the process returns to 204 and reception of a subsequent packet stands by. The setting of the monitoring stop packet is optional. In a case in which the monitoring stop packet is not defined, the processes of 210 and 211 are omitted.

In the process of 213, the processor 203 executes an update process on the recovery state. As described above, the recovery state is transitioned (escalated) one step by one step such as “recovery 1” “recovery 2” . . . in a case in which the process of 213 is executed using “normal” as an initial value.

In the process of 214, the processor 203 notifies the opposite apparatus of an instruction to update the recovery state using the IKE packet. In the process of 215, the processor 203 reads the recovery method corresponding to the recovery state from the “recovery method” included in the monitoring information 204c.

In the process of 216, the processor 203 determines whether the recovery method is executed on the monitoring side. In a case in which the recovery method is executed on the monitoring side (Yes of 216), the process proceeds to 217. In a case in which the recovery method is executed on the monitored side (No of 216), the process proceeds to 219.

In the process of 217, the processor 203 determines whether the recovery method is “completely switched” and a redundant apparatus is unswitchable (whether the recovery method is unexecutable). In a case in which the recovery method is “completely switched” and the redundant apparatus is unswitchable (Yes of 217), the process returns to 201. Conversely, in a case in which the recovery method is “completely switched” and the redundant apparatus is not unswitchable (No of 217), the process returns to 218. In the process of 218, the processor 203 executes the recovery method. Thereafter, the process returns to 201.

In the process of 219, the processor 203 determines whether the recovery method is “completely switched” and the redundant apparatus is unswitchable (whether the recovery method is unexecutable). In the case in which the recovery method is “completely switched” and the redundant apparatus is unswitchable (Yes of 219), the process returns to 201. Conversely, in the case in which the recovery method is “completely switched” and the redundant apparatus is not unswitchable (No of 219), the process returns to 220. In the process of 220, the processor 203 instructs the opposite apparatus (the monitoring side) of the recovery method using the IKE packet. In this way, the recovery method is executed on the monitoring side. Thereafter, the process returns to 201.

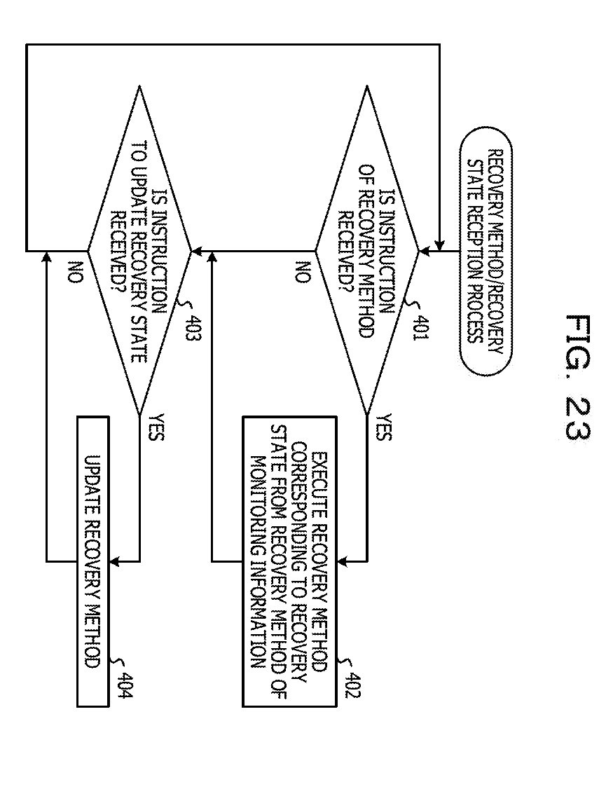

FIG. 23 is a flowchart illustrating an example of a recovery method/recovery state reception process. The process of FIG. 23 is executed by, for example, the processor 203 operating as the control unit 202 (303).

In the process of 401, the processor 203 determines whether an instruction of the recovery method is received. In a case in which the instruction of the recovery method is received (Yes of 401), the process proceeds to 402. Otherwise (No of 401), the process proceeds to 403. In the process of 402, the processor 203 executes the recovery method corresponding to the recovery state from the “recovery method” of the monitoring information 204c.

In the process of 403, the processor 203 determines whether an instruction to update the recovery state is received. In a case in which the instruction to update the recovery state is received (Yes of 403), the process proceeds to 404. Otherwise (No of 403), the process returns to 401. In the process of 404, the processor 203 updates the “recovery method” of the monitoring information 204c. That is, the processor 203 causes content of the recovery method to proceed by one step.

Next, examples of the formats of messages (packets) used in the embodiment will be described.

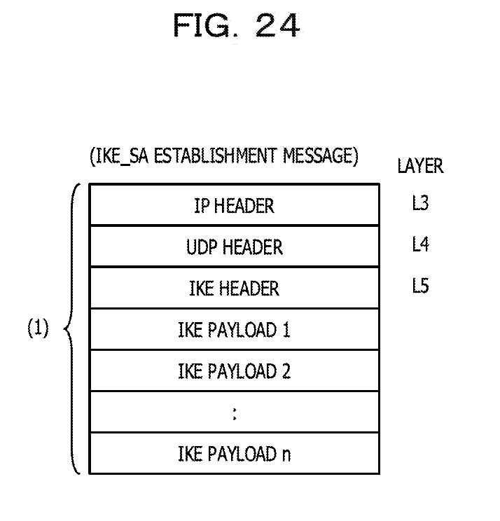

FIG. 24 illustrates an example of the format of the IKE packet. In the IKE packet, a user datagram protocol (UDP) header (L4) and an IP header (L3) are granted to an IKE header and IKE payloads 1, 2, . . . , n−1, n (where n is a positive integer) as data of layer 5 (L5: a session layer). In FIG. 24, (1) indicates non-encryption regions.

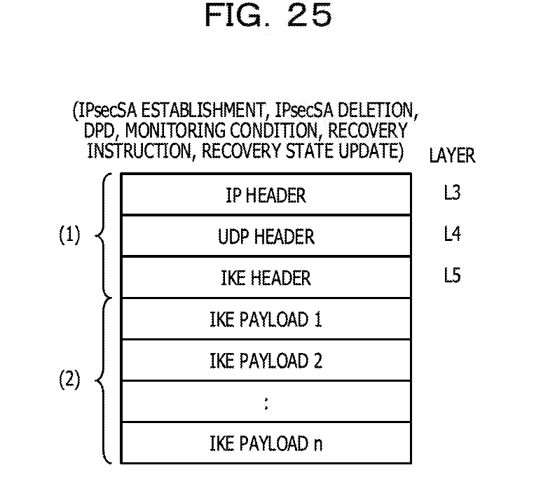

FIG. 25 illustrates an example of the format of the negotiation packet, that is, the IKE packet used as the IPsec_SA establishment message. As illustrated in FIG. 25, the format is the same as that of the IKE packet illustrated in FIG. 24. Here, payload portions of the IKE indicated by (2) of FIG. 25 are encryption regions encrypted with a key of the IKE. On the other hand, header portions indicated by (1) of FIG. 25 are non-encryption regions.

A message of an IPsec_SA deletion request, a DPD message, a negotiation packet of the monitoring condition, a message of an instruction of the recovery method, and a message of an instruction to update the recovery state also have the same format as the IPsec_SA establishment message.

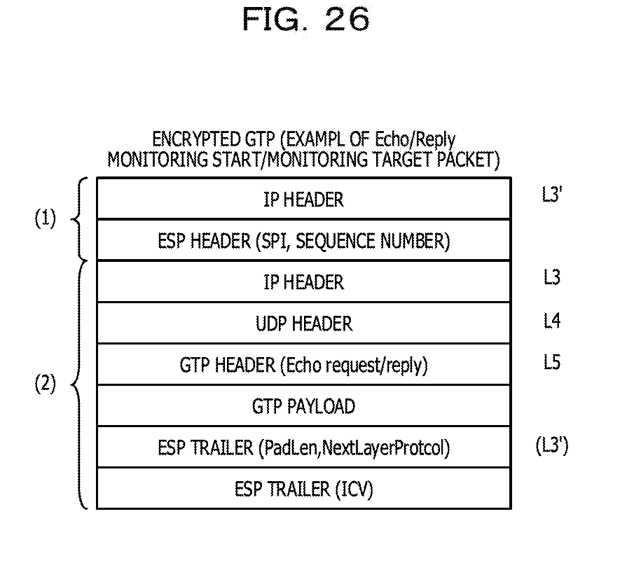

FIG. 26 illustrates an example of the format of the monitoring start/monitoring target packet. In the example of FIG. 26, a general packet radio system tunneling protocol (GTP) is illustrated as an example of the upper layer.

In FIG. 26, the monitoring start/monitoring target packet includes encryption regions indicated by (2) and non-encryption regions indicated by (1). The encryption regions include an IP header, a UDP header, a GTP header, a GTP payload, and an ESP trailer. The non-encryption regions include an IP header, an ESP header, and an ESP trailer.

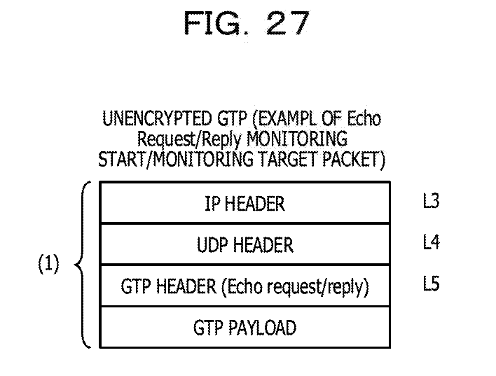

FIG. 27 illustrates an example of the format of an unencrypted monitoring start/monitoring target packet. In the example of FIG. 27, the monitoring start packet is a GTP echo request packet and the monitoring target packet is a GTP echo reply packet.

The DPD which is a technology of the related art, negotiation abnormality of a user packet which is caused due to the following factors is undetectable in a state in which the IKE_SA is established:
mismatch of retrieval logic (association between a user packet and the SPD to be applied) of a security policy database (SPD) between an own apparatus and a opposite apparatus;
mismatch of a cipher key of the IPsec_SA
abnormality of an encryption process by the IPsec_SA;
unusability of the SA by life timer expiration of the IPsec_SA; and
mismatch of an upper sequence number in an extended sequence number in an encapsulated security payload (ESP) header.

In the embodiment, when abnormality is present in the IPsec_SA (encapsulation tunnel) despite of the establishment of the IKE_SA, abnormality (communication abnormality of an upper layer) transmission and reception of the packet of the upper layer caused due to the abnormality can be detected. Further, at the time of detection of the abnormality, a predetermined recovery method can be executed to achieve recovery from an abnormal (failure) state. In this way, it is possible to achieve early recovery from a failure of a network and a stable operation of the network.

Therefore, in the embodiment, the monitoring conditions and the recovery methods are stored in advance in information (the SPD 204a) for negotiation of the IPsec_SA, and negotiation of the monitoring conditions and the recovery methods is also executed along with negotiation of the IPsec_SA. In this way, abnormality of encryption communication can be detected without increasing a load of an apparatus executing the IPsec (encryption communication). However, of the monitoring conditions and the recovery methods, only the monitoring conditions can be included in the negotiation packet.

In other words, the monitoring conditions are defined using packet specifying parameters (an IP address, a port number, a protocol, a type, and the like) originally present in the SPD and the monitoring conditions are negotiated along with negotiation of the IPsec_SA. According to a result of the negotiation, transmission and reception statuses (negotiation) of packets of an upper layer are monitored. In accordance with addition of such a simple configuration, it is possible to detect abnormality of the IPsec_SA undetectable in a case in which the IKE_SA is normally established. That is, in accordance with the simple configuration, it is possible to detect abnormality of encryption communication undetectable in monitoring using a lower layer. Further, in the embodiment, it is possible to also negotiate the recovery method and execute a process based on the recovery method at the time of detection of abnormality.

The monitoring side presents a plurality of proposals (candidates) for the monitoring condition and the recovery method to the monitored side (the opposite apparatus), and the opposite apparatus replies about a selection result of the proposal. In this way, it is possible to adopt the abnormal detection and the recovery method which can be executed by the opposite apparatus.

In the embodiment, the monitoring condition and the recovery method are set in the SPD owned by an apparatus serving as an entity (one of an initiator and a responder) of the IPsec. In this way, a maintenance person can set the monitoring condition and the recovery method for general use using the SPD.

In introduction of the monitoring according to the embodiment, normality of negotiation (connectivity) of an upper layer including the IPsec layer can be monitored without changing an operation of the upper layer (GTP, SCTP, ICMP, or the like).

In a case in which the IPsec is applied, an IP address, a protocol, an algorithm, and the like to which the IPsec is applied with the SPD are designated. In the embodiment, signal conditions (the monitoring start packet, the monitoring target packet, and the monitoring stop packet) of the upper layer can be specified using specific information regarding a flow to a traffic of the IPsec, such as the IP address, the protocol, and the type. Accordingly, the parameters can be unitarily managed in relation to each of the establishment of the IPsec_SA, the monitoring condition, and the recovery method. The setting method can also be unified and application to an existing apparatus is assumed to be easy.

In the embodiment, the monitoring start packet and the monitoring target packet are designated along with negotiation information related to the establishment of the IPsec_SA with the opposite apparatus. In this way, it is possible to reduce a labor of the negotiation, and thus it is possible to avoid potentiality of a problem and erroneous detection.

In the embodiment, the plurality of recovery methods are readily executed and one recovery method is used step by step. Therefore, the recovery method can be selected and used so that an influence occurring in use of the recovery method is suppressed. Further, even in a case in which the opposite apparatus does not have all of the recovery methods (candidates) related to the proposals, recovery using an operation having the IPsec function of the related art can be implemented. Therefore, the recovery can be executed by applying a monitoring side apparatus.

Even in a case in which the opposite apparatus treats only some of the recovery methods related to the proposals, treatable recovery methods can be used. It is possible to designate the conditions of the monitoring start packet and the monitoring target packet in detail, and thus it is possible to execute monitoring according to characteristics of the upper layer by changing the parameters in the SPD.

In the embodiment, the monitoring stop packet can be set. In this way, in a case in which abnormality occurs in an operation of the upper layer in a non-monitoring state, it is possible to avoid abnormality and erroneous detection of the lower layer (the IPsec).

In the embodiment, the recovery state can be stored in a nonvolatile storage medium. In this way, even in a case in the recovery method according to the reset of the apparatus is executed, the recovery method of a subsequent candidate can be implemented with the recovery state maintained. Accordingly, it is possible to correspond to various recovery patterns.

In a case in which the path of the IPsec has a redundant configuration, it is possible to also recover a failure of a case in which one-side IPsec apparatus and the path are causes. By executing application to the IPsec function embedded in the wireless base station apparatus, it is possible to maintain the network system of stable wireless communication. The configurations according to the above-described embodiment can be appropriately combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. For example, the steps recited in any of the process or method descriptions may be executed in any order and are not limited to the order presented.

What is claimed is:

1. A communication apparatus, the apparatus comprising:
a memory configured to store negotiation information used to negotiate a path of encryption communication established with a opposite apparatus; and
a processor coupled to the memory and configured to execute a monitoring process, the monitoring process including a process of monitoring a monitoring target packet specified using the negotiation information among a plurality of packets transmitted and received on the path, and a process of detecting abnormality of the encryption communication in a case in which the monitoring target packet is not received within a predetermined time.

2. The apparatus according to claim 1,
wherein the processor is configured to execute a recovery process, the recovery process including a process of executing a recovery method specified using the negotiation information in a case in which the abnormality of the encryption communication is detected.

3. The apparatus according to claim 1,
wherein the processor is configured to execute a negotiation process, the negotiation process including:
a process of putting information for negotiation of the monitoring target packet included in the negotiation information into a message for the negotiation of the path and transmitting the message to the opposite apparatus; and
a process of receiving a reply message including a result of the negotiation of the path and a negotiation result of the monitoring target packet, and
wherein the monitoring process includes a process of monitoring the monitoring target packet specified based at least in part on the negotiation result of the monitoring target packet.

4. The apparatus according to claim 1,
wherein the processor is configured to execute a negotiation process, the negotiation process including:
a process of putting information for negotiation of the monitoring target packet and information for negotiation of a recovery method included in the negotiation information into a message of establishment negotiation of the path and transmitting the message to the opposite apparatus; and
a process of receiving a reply message including a negotiation result of the path, a negotiation result of the monitoring target packet, and a negotiation result of the recovery method,
wherein the monitoring process includes a process of monitoring the monitoring target packet specified based at least in part on the negotiation result of the monitoring target packet, and
wherein the recovery process includes executing a recovery method specified based at least in part on the negotiation result of the recovery method.

5. The apparatus according to claim 3,
wherein the information for the negotiation of the monitoring target packet includes a plurality of candidates of the monitoring target packet, and
wherein the monitoring process includes a process of monitoring at least one monitoring target packet selected by the opposite device from the plurality of candidates of the monitoring target packet.

6. The apparatus according to claim 4,
wherein the information for the negotiation of the recovery method includes a plurality of candidates of the recovery method, and
wherein the monitoring process includes executing at least one recovery method selected by the opposite apparatus from the plurality of candidates of the recovery method.

7. The apparatus according to claim 1,
wherein the negotiation information stored in the memory includes specific information of a target packet of the encryption communication and specific information of the monitoring target packet regulated using a common information item.

8. The apparatus according to claim 2,
wherein the recovery process includes executing a recovery method corresponding to a recovery state stored in a nonvolatile storage medium among a plurality of recovery methods decided in the negotiation with the opposite apparatus.

9. A method for detecting abnormality of encryption communication, the method comprising:
storing negotiation information for negotiating a path of the encryption communication to be established with a opposite apparatus; and
detecting abnormality of the encryption communication in a case in which a monitoring target packet specified using the negotiation information is not received within a predetermined time, the monitoring target packet being a packet transmitted or received on the path.
